(19) United States
(12) Patent Application Publication
(10) Pub. No.: US 2024/0262707 A1
(43) Pub. Date: Aug. 8, 2024

(54) CATHODE MATERIALS FOR SECONDARY BATTERIES

(71) Applicant: UCHICAGO ARGONNE, LLC, Chicago, IL (US)

(72) Inventors: Alvin Dai, Bolingbrook, IL (US); Tongchao Liu, Westmont, IL (US); Khalil Amine, Oakbrook, IL (US)

(73) Assignee: UCHICAGO ARGONNE, LLC, Chicago, IL (US)

(21) Appl. No.: 18/105,469

(22) Filed: Feb. 3, 2023

(51) Int. Cl. C01G 53/00; H01M 10/0525

(52) U.S. Cl. CPC C01G 53/006; C01G 53/50; H01M 10/0525; C01P 2002/30

(57) ABSTRACT

A cathode active material includes a plurality of cathode active particles, each particle being of a composition expressed as:

[Li_{1+γ}(NiₓMn_{y}Co_{z})_{1-γ}O₂]_{α}^{M1}[Li_{1+δ}(Ni_{x′}Mn_{y′}Co_{z′})_{1-δ}O₂]_{β}^{M2}[Li_{1+ε}(Ni_{x″}Mn_{y″}Co_{z″})_{1-ε}O₂]_{1-α-β}^{M3}; or

[Na_{1+γ}(NiₓMn_{y}Co_{z})_{1-γ}O₂]_{α}^{M1}[Na_{1+δ}(Ni_{x′}Mn_{y′}Co_{z′})_{1-δ}O₂]_{β}^{M2}[Na_{1+ε}(Ni_{x″}Mn_{y″}Co_{z″})_{1-ε}O₂]_{1-α-β}^{M3};

wherein: M1 is a structure having a layered phase; M2 has structure comprising a Mn-rich and/or spinel phase; M3 has a rock salt or disordered rock salt phase; M1, M2, and M3 have different formulae; an inner most core portion of the particle is one of M1, M2, or M3; an interlayer may be any one of the remaining two of M1, M2, or M3; an outer most layer may be the remaining member of M1, M2, or M3; 0≤α<1, 0<β<1, −0.1≤γ≤0.1, −0.3≤δ≤0.3, −0.5≤ε≤0.5, 0≤x≤1, 0≤y≤0.5, 0≤z≤1, 0≤x′≤0.5, 0.5≤y′≤1, 0≤z′≤0.5, and 0≤x″≤1, 0≤y″≤1, 0≤z″≤1; and the sum of x, y and z is 1, the sum of x′, y′ and z′ is 1, and the sum of x″, y″, and z″ is 1.

### GOVERNMENT RIGHTS

This invention was made with government support under Contract No. DE-AC02-06CH11357 awarded by the United States Department of Energy to UChicago Argonne, LLC, operator of Argonne National Laboratory. The government has certain rights in the invention.

### FIELD

The present technology is generally related to cathode materials for lithium-ion batteries or sodium-ion batteries, and methods to prepare secondary batteries containing the same. More specifically, the present technology is related to particulate cathode materials for lithium/sodium ion batteries, the particles having a concentration gradient that varies in both chemical composition and structure along a vector radius of the particles. The concentration gradients may be multi layered, result in improved electrochemical performance, and suppress or significantly reduce micro-cracks that are typically generated during repeated lithium-ion or sodium-ion insertion and/or desertion.

### BACKGROUND

Lithium-ion batteries provide energy density and usable life that far surpass other forms of electrochemical energy storage. This has enabled them to be widely applied in commercial devices such as portable electronics and electric vehicles. However, expensive materials used in cathode materials such as cobalt prevent reductions in battery cost and limit usable capacity. In order to lower prices and raise energy density, novel cathode materials that are cheaper and can operate at extreme cycle conditions are needed.

Cathode materials rich in nickel exhibit capacity and power capabilities that enable them to be a next-generation cheaper alternative to cobalt containing cathodes. As nickel contents increase, high specific energy, and high energy density are achievable. However, structural instability of nickel-rich cathodes, especially at high voltage, impede practical use as fast capacity decay and low thermal-abuse tolerance are present. At high voltages in particular, the cathode is in a highly de-lithiated state that may exacerbate parasitic side reactions leading to structural degradation, morphological damage, transition metal dissolution, and oxidization of the organic electrolyte. These modes of failure primarily occur on cathode particle surfaces and lead to poor cyclability and rate capability.

With global efforts to further improve performance and reduce cost in commercial batteries, there is motivation to enhance the performance of Li[NiₓMn_{y}Co_{z}]O₂ (“NMC”)-based electrochemical cells through new structure designs. Previous developments include breakthroughs that simultaneously controlled local Ni composition in the bulk cathode material and the surface composition of a single NMC particle to improve structure/thermal stability and capacity. For this, see U.S. Patent Publication Nos. 2014/0027670 and 2016/0260965. Other novel structures include core-shell structures and concentration gradient structures, see Nature Mater. 2009, 8(4): 320 and Nature Mater. 2012, 11(11): 942. In these cathode structure designs, particles contain a Ni-rich core composition that provides high capacity and Mn-rich surface to improve structural stability. When moving from particle centers to outer layers, Ni concentrations are reduced while Mn concentrations are increased. Cobalt contents remain constant and are less than 20% of the transition metal ratio. Through these approaches, cycle performances were significantly enhanced and crack formations were reduced at conventional voltage operational windows (e.g., less than 4.4 V).

A viable strategy to further improve energy density in batteries is to operate at higher voltages, however surface side reactions and structure evolution related to Ni and Mn components are exacerbated. These detrimental effects include surface electrolyte reactions, oxygen release, and Mn dissolution that accelerate consumption of usable capacity in NMC cathode. For example, see Angew. Chem. Int. Ed. 2015, 54: 4440. Also, Ni-rich cathode structures are confirmed to exhibit thermodynamic instability at high potentials as transition metals (TMs) will migrate and form new structures. For this, see Adv. Energy Mater. 2018, 8: 1702028. These combined factors simultaneously dictate the mechanism for capacity decay in Ni-rich materials, while also hindering efforts to improve both energy density and high-voltage functionality in Ni-rich cathodes.

### SUMMARY

In one aspect, a cathode active material is provided including: a composition expressed as:

[Li_{1+γ}(NiₓMn_{y}Co_{z})_{1-γ}O₂]_{α}^{M1}[Li_{1+δ}(Ni_{x′}Mn_{y′}Co_{z′})_{1-δ}O₂]_{β}^{M2}[Li_{1+ε}(Ni_{x″}Mn_{y″}Co_{z″})_{1-ε}O₂]_{1-α-β}^{M3}; or

[Na_{1+γ}(NiₓMn_{y}Co_{z})_{1-γ}O₂]_{α}^{M1}[Na_{1+δ}(Ni_{x′}Mn_{y′}Co_{z′})_{1-δ}O₂]_{β}^{M2}[Na_{1+ε}(Ni_{x″}Mn_{y″}Co_{z″})_{1-ε}O₂]_{1-α-β}^{M3};

wherein: M1 is a structure having a layered phase; M2 has structure comprising a Mn-rich and/or spinel phase; M3 has a rock salt or disordered rock salt phase; M1, M2, and M3 have different formulae; an inner most core portion of the particle may be of a group of M1, M2, or M3; an interlayer may be any one of the remaining two of the group; an outer most layer may be the remaining member of the group; 0≤α<1, 0<β<1, −0.1≤γ≤0.1, −0.3≤δ≤0.3, −0.5≤ε≤0.5, 0≤x≤1, 0≤y≤0.5, 0≤z≤1, 0≤x′≤0.5, 0.5≤y′≤1, 0≤z′≤0.5, and 0≤x″≤1, 0≤y″≤1, 0≤z″≤1; and the sum of x, y and z is 1, the sum of x′, y′ and z′ is 1, and the sum of x″, y″, and z″ is 1. In some such embodiments, the particle comprises M1 as the inner most core, M2 as the interlayer, and M3 as the outer most layer. In other such embodiments, the particle comprises M2 as the inner most core, M3 as the interlayer, and M3 as the outer most layer. In some embodiments, the outer most layer is from 0.01 to 2 μm in thickness.

In another aspect, a cathode active material is provided including: a composition expressed as:

[Li_{1+γ}(NiₓMn_{y}Co_{z})_{1-γ}O₂]_{α}^{M1}[Li_{1+δ}(Ni_{x′}Mn_{y′}Co_{z′})_{1-δ}O₂]_{β}^{M2}[Li_{1+ε}(Ni_{x″}Mn_{y″}Co_{z″})_{1-ε}O₂]_{φ}^{M3}[Li_{1+μ}(Ni_{x′″}Mn_{y′″}Co_{z′″})_{1-μ}O₂]_{1-α-β-φ}^{MX}; or

[Na_{1+γ}(NiₓMn_{y}Co_{z})_{1-γ}O₂]_{α}^{M1}[Na_{1+δ}(Ni_{x′}Mn_{y′}Co_{z′})_{1-δ}O₂]_{β}^{M2}[Na_{1+ε}(Ni_{x″}Mn_{y″}Co_{z″})_{1-ε}O₂]_{φ}^{M3}[Na_{1+μ}(Ni_{x′″}Mn_{y′″}Co_{z′″})_{1-μ}O₂]_{1-α-β-φ}^{MX};

wherein: M1 is a structure comprising a layered phase; M2 is a structure comprising a Mn-rich and/or spinel phase; M3 is a structure comprising a rock-salt or disordered rock-salt phase; MX is a composite structure comprising a layered, Mn-rich, and/or spinel, or rock salt and/or disordered rock salt phase; MX is absent or present and when present represents additional layers where X is greater than 3; 0≤α<1, 0<β<1, 0<φ<1, −0.1≤γ≤0.1, −0.3≤δ≤0.3, −0.5≤ε≤0.5, −0.7≤μ≤0.7, 0≤x≤1, 0≤y≤0.5, 0≤z≤1, 0≤x′≤0.5, 0.5≤γ′≤1, 0≤z′≤0.5, 0≤x″≤1, 0≤y″≤1, 0≤z″≤1, and 0≤x′″≤1, 0≤y′″≤1, and 0≤z′″≤1; and the sum of x, y and z is 1, the sum of x′, y′ and z′ is 1, the sum of x″, y″, and z″ is 1, and the sum of x′″, y′″, and z′″ is 1.

In a further aspect, a process of preparing a cathode active material is provided that includes providing a first aqueous metal ion solution; providing a second aqueous metal ion solution; providing a third aqueous metal ion solution; optionally, providing additional aqueous metal ion solutions X where X>3; combining the first, second, third, and, optionally additional metal solutions with a precipitating agent to form a precipitate; isolating the precipitate; mixing the precipitate with a lithium or sodium salt to form a mixture; and heating-treating the mixture to form the cathode active material that is expressed as:

[Li_{1+γ}(NiₓMn_{y}Co_{z})_{1-γ}O₂]α^{M1}[Li_{1+δ}(Ni_{x′}Mn_{y′}Co_{z′})_{1-δ}O₂]_{β}^{M2}[Li_{1+ε}(Ni_{x′}Mn_{y′}Co_{z′})_{1-ε}O₂]_{1-α-β}^{M3}; or

[Na_{1+γ}(NiₓMn_{y}Co_{z})_{1-γ}O₂]α^{M1}[Na_{1+δ}(Ni_{x′}Mn_{y′}Co_{z′})_{1-δ}O₂]_{β}^{M2}[Na_{1+ε}(Ni_{x″}Mn_{y″}Co_{z″})_{1-ε}O₂]_{1-α-β}^{M3};

wherein: M1 represents a structure having a layered phase; M2 represents a structure having a Mn-rich and/or spinel phase; M3 represents a structure having a rock-salt or disordered rock-salt phase; M1 is the inner most core, M2 is an interlayer, M3 is an outer most layer, and MX is optional additional interlayers, or M2 is the inner most core, M1 is an interlayer, M3 is an outer most layer, and MX is optional additional interlayers; 0≤α<1, 0<β<1, −0.1≤γ≤0.1, −0.3≤δ≤0.3, −0.5≤ε≤0.5, 0≤x≤1, 0≤y≤0.5, 0≤z≤1, 0≤x′≤0.5, 0.5≤y′≤1, 0≤z′≤0.5, and 0≤x″≤1, 0≤y″≤1, 0≤z″≤1; and the sum of x, y, and z is 1, the sum of x′, y′, and z′ is 1, and the sum of x″, y″, and z″ is 1.

### BRIEF DESCRIPTION OF THE DRAWINGS

FIG. 1 is a transition metal component schematic and graphically a Ni-rich cathode material, which at any given point in the particle, it may be expressed as [Li_{1+γ}(NiₓMn_{y}Co_{z})_{1-γ}O₂]_{α}^{M1}[Li_{1+δ}(Ni_{x′}Mn_{y′}Co_{z′})_{1-δ}O₂]β^{M2}[Li_{1+ε}(Ni_{x″}Mn_{y″}Co_{z″})_{1-ε}O₂]_{1-α-β}^{M3} where M1, M2, and M3 denote unique material structures that correspond to layered, Mn-rich, and rock salt or disordered rock salt respectively; M1 represents the inner most core composition including Ni, Mn, Co, or a combination of two or more thereof; M2 represents the interlayer component consisting of 50 mol % or more Mn, and that may contain Ni, and Co; M3 represents the outer most layer surface including 75 mol % or greater of Mn, and that may contain Ni and Co; where 0≤α<1, 0<β<1, −0.1≤γ≤0.1, −0.3≤δ≤0.3, −0.5≤ε≤0.5, 0≤x≤1, 0≤y≤0.5, 0≤z≤1, 0≤x′≤0.5, 0.5≤y′≤1, 0≤z′≤0.5, and 0≤x″≤1, 0≤y″≤1, 0≤z″≤1; and the sum of x, y and z is 1, the sum of x′, y′ and z′ is 1, and the sum of x″, y″, and z″ is 1.

FIG. 2A depicts a concentration profile for a cathode material expressed as [Li_{1+γ}(NiₓMn_{y}Co_{z})_{1-γ}O₂]_{α}^{M1}[Li_{1+δ}(Ni_{x′}Mn_{y′}Co_{z′})_{1-δ}O₂]_{β}^{M2} [Li_{1+ε}(Ni_{x″}Mn_{y″}Co_{z″})_{1-ε}O₂]_{1-α-β}^{M3}, wherein the Ni concentration is constant in the core and decreases to 25% in the surface; the Mn concentration is constant in the core and increases to 75 mol % at the surface; and the Co concentration is constant in the core and decreases to 0 mol % at the surface and interlayer. FIG. 2B is a structure profile, where the Co concentration increases to 12 mol % instead of decreases. The multi-layer structure is present in both arrangements where Co can increase or decrease.

FIG. 3A is a concentration profile for a cathode material expressed as [Li_{1+γ}(NiₓMn_{y}Co_{z})_{1-γ}O₂]_{α}^{M1}[Li_{1+δ}(Ni_{x′}Mn_{y′}Co_{z′})_{1-δ}O₂]_{β}^{M2}[Li_{1+ε}(Ni_{x″}Mn_{y″}Co_{z″})_{1-ε}O₂]_{1-α-β}^{M3} with a two-slope concentration gradient, wherein the Ni concentration is constant in the core and decreases to 25% in the surface; the Mn concentration is constant in the core and increases to 75 mol % at the surface; and the Co concentration is constant in the core and decreases to 0 mol % at the surface and interlayer. FIG. 3B depicts a representative structure profile where Co concentration increases to 12 mol % instead of decreases. The multi-layer structure is present in both arrangements where Co can increase or decrease.

FIG. 4 is a transition metal component schematic and graphically a Mn-rich cathode material, which at any given point in the particle, it may be expressed as [Li_{1+γ}(NiₓMn_{y}Co_{z})_{1-γ}O₂]_{α}^{M2}[Li_{1+δ}(Ni_{x′}Mn_{y′}Co_{z′})_{1-δ}O₂]β^{M1}[Li_{1+ε}(Ni_{x″}Mn_{y″}Co_{z″})_{1-ε}O₂]_{1-α-β}^{M3}, where this structure differs from FIG. 1 as M2 is the inner most core, M1 the interlayer, and M3 remains as the outermost layer; where M1 represents the interlayer composition including Ni, Mn, Co, or a combination of two or more thereof, M2 represents the inner most core component having 50 mol % or greater Mn, and/or Co or Ni; M3 represents the outer most layer surface having 75 mol % or greater Ni, and that may contain Mn and Co; where 0<α<1, 0≤β<1, −0.3≤γ≤0.3, −0.1≤δ≤0.1, −0.5≤ε≤0.5, 0≤x≤0.5, 0.5≤y≤1, 0≤z≤0.5, 0≤x′≤1, 0≤y′≤0.5, 0≤z′≤1, and 0≤x″≤1, 0≤y″≤1, 0≤z″≤1. Here M1, M2, and M3 also denote material structures that correspond to layered, Mn-rich, and rock salt or disordered rock salt respectively.

FIG. 5A is a concentration profile for a cathode material expressed as [Li_{1+γ}(NiₓMn_{y}Co_{z})_{1-γ}O₂]_{α}^{M2}[Li_{1+δ}(Ni_{x′}Mn_{y′}Co_{z′})_{1-δ}O₂]β^{M1}[Li_{1+ε}(Ni_{x″}Mn_{y″}Co_{z″})_{1-ε}O₂]_{1-α-β}^{M3} wherein the Mn concentration is constant in the core and decreases to 0% at the surface; the Co concentration is constant in the core and decreases to 0 at the surface; and the Ni concentration is absent in the core and then increases from 0 to 100 mol % at the surface. FIG. 5B is a structure profile same as FIG. 5A where Co concentration increases to 12 mol % instead of decreases. The multi-layer structure is present in both arrangements where Co can increase or decrease. In addition, a two-slope concentration gradient profile is also depicted in this figure. FIG. 5C is a concentration profile for a cathode material expressed as [Li_{1+γ}(NiₓMn_{y}Co_{z})_{1-γ}O₂]_{α}^{M2}[Li_{1+δ}(Ni_{x′}Mn_{y′}Co_{z′})_{1-δ}O₂]β^{M1}[Li_{1+ε}(Ni_{x″}Mn_{y″}Co_{z″})_{1-ε}O₂]_{1-α-β}^{M3} wherein the Mn concentration is constant in the core and decreases to 0% at the surface; the Ni concentration is constant in the core and decreases to 0 at the surface; and the Co concentration is absent in the core and then increases from 0 to 100 mol % at the surface. FIG. 5D is a structure profile where the Ni concentration increases to 12 mol %, instead of decreasing. The multi-layer structure is present in both arrangements where Ni can increase or decrease. In addition, a two-slope concentration gradient profile is also depicted in this figure.

FIG. 6 shows potential combinations for the arrangement of M1, M2, and M3 structures which correspond to layered, Mn-rich, and rock salt or disordered rock salt respectively. M3 may be included as the inner most core, while M1 and M2 can switch positions from being the interlayer and outer most layer. M3 can also compose in the interlayer, while M1 and M2 can switch positions being the inner most core and outer most layer. All combinations shown are representative of the multi-structure design.

FIGS. 7A and B are scanning electron microscopy images of the Example 2 Ni-rich precursor and having a spherical and uniform particle size with an average size of about 12 m. FIG. 7A is at a higher magnification than FIG. 7B.

FIGS. 8A and 8B are scanning electron microscopy images of the Example 2 Ni-rich cathode expressed as [Li_{1+γ}(NiₓMn_{y}Co_{z})_{1-γ}O₂]_{α}^{M1}[Li_{1+δ}(Ni_{x′}Mn_{y′}Co_{z′})_{1-δ}O₂]_{β}^{M2}[Li_{1+ε}(Ni_{x″}Mn_{y″}Co_{z″})_{1-ε}O₂]_{1-α-β}^{M3} and having a spherical and uniform particle size having with an average size of around 12 μm. The single particle of FIG. 8A is one of the bulk particles from FIG. 8B.

FIG. 9A depicts a TEM EDS (energy dispersive x-ray spectroscopy) image confirming the formation of Ni-rich cathode material expressed as [Li_{1+γ}(NiₓMn_{y}Co_{z})_{1-γ}O₂]_{α}^{M1}[Li_{1+δ}(Ni_{x′}Mn_{y′}Co_{z′})_{1-δ}O₂]_{β}^{M2}[Li_{1+ε}(Ni_{x″}Mn_{y″}Co_{z″})_{1-ε}O₂]_{1-α-β}^{M3} according to Example 2. Mn-rich and rock salt or disordered-rock salt structures are observable on the Ni-rich inner most core.

FIG. 9B is a three axis graph showing possible combinations of material in the active material. The images show that the Ni concentration decreases from 89 mol % to 0 mol % from the core to the surface; the Mn concentration increases from 6 mol % to 100 mol % from the core to the surface; and the Co concentration decreases from 6 mol % to 0 mol % from the core to the surface.

FIG. 10A is a high resolution transmission electron microscopy (TEM) images, providing structural characterization for the interlayer of Example 2 Ni-rich cathode expressed as [Li_{1+γ}(NiₓMn_{y}Co_{z})_{1-γ}O₂]_{α}^{M1}[Li_{1+δ}(Ni_{x′}Mn_{y′}Co_{z′})_{1-δ}O₂]_{β}^{M2}[Li_{1+ε}(Ni_{x″}Mn_{y″}Co_{z″})_{1-ε}O₂]_{1-α-β}^{M3}. The atomic structure of the inner most core is a layered structure, and the atomic interlayer structure is Mn-rich as evidenced by the faint trace lines (denoted by arrows) present between ordered lattice bright points. FIG. 10B depict TEM images 1-6 moving from the interlayer to inner most core of the Ni-rich cathode of Example 2. Images 1-6 denote the transition from interlayer to inner most core, where the faint Mn-rich characteristic traces fade during the transition to inner most core.

FIG. 11A is a TEM image, providing structural characterization for the outer most layer of Example 2 Ni-rich cathode expressed as [Li_{1+γ}(NiₓMn_{y}Co_{z})_{1-γ}O₂]_{α}^{M1}[Li_{1+δ}(Ni_{x′}Mn_{y′}Co_{z′})_{1-δ}O₂]_{β}^{M2}[Li_{1+ε}(Ni_{x″}Mn_{y″}Co_{z″})_{1-ε}O₂]_{1-α-β}^{M3}. The atomic structure of the inner most core is a layered structure, the atomic interlayer structure is Mn-rich, and the outer most layer is rock salt. The outer most rock salt layer is denoted by the antisites and arrows, where bright points are observable in the typically dark lithium layers. The regions enclosed by boxes also show faint points in typically well-ordered bright transition metal regions, which is a characteristic of rock salt. FIG. 11B includes TEM images of the outer most layer of Example 2 Ni-rich cathode where a rock salt or disordered rock salt layer is present. The boundary between the inner most core, Mn-rich interlayer, and rock salt outer most layer is marked by the dashed line. As used herein, the term “antisites” describes sites of a structure where transition metals (Ni, Co, or Mn) in a lattice are exchanged with Li. Typically, the metals and Li are in separate layers respectively. A significant number of antisites are what define a rock salt structure composition. This is evident in FIG. 11, where some bright points are typically observed in the dark Li layer.

FIGS. 12A and 12B are charge/discharge voltage profiles (12A) and cycle performance (12B) of the first 3 cycles at a charge/discharge rate of C/10 and following 100 cycles at a charge/discharge rate of C/2 at a voltage of 2.8 V to 4.4 V for the Example 2 Ni-rich cathode.

FIGS. 13A and 13B are charge/discharge voltage profiles (13A) and cycle performance (13B) of the first 3 cycles at a charge/discharge rate of C/10 and following 100 cycles at a charge/discharge rate of C/2 at a voltage of 2.8 V to 4.5 V for the Example 2 Ni-rich cathode.

FIGS. 14A and 14B are charge/discharge voltage profiles (14A) and cycle performance (14B) of the first 3 cycles at a charge/discharge rate of C/10 and following 100 cycles at a charge/discharge rate of C/2 at a voltage of 2.8 V to 4.6 V for the Example 2 Ni-rich cathode.

FIG. 15 are the full cell cycle performance of Example 2 operating at a current rate of the first 3 cycles at a charge/discharge rate of C/10 and following 300 cycles at a charge/discharge rate of C/2 at a voltage of 2.8 V to 4.4 V, respectively.

FIGS. 16A and 16B are charge/discharge voltage profiles (16A) and cycle performance (16B) of uniform NMC811 (Ni 80 mol %, Mn 10 mol %, and Co 10 mol %) for the first cycle at a charge/discharge rate of C/10 and following 100 cycles at a charge/discharge rate of C/2 at a voltage of 2.8 V to 4.6 V.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

As used herein the term “vector radius” is used to show a directionality of the radius of the particle from the center to the surface. The particles are generally spherical and thus characterized by the vector radius, however even where the particles do not have a general spherical shape or an irregular spherical or oblate spheroid shape, the radius may be approximated as any radial measurement from a mean center to a surface. In particular, and differing from prior art concentration gradient cathodes, the newly designed multi structure concentration gradient cathode mainly controls the distribution of Mn in the whole particle, rather than that of Ni.

Further, although the terms “core solution,” “core composition,” “inner most core,” “interlayer solution,” “interlayer composition,” “outer most layer solution,” and “outer most layer composition” are used herein, they do not refer to a traditional meaning of core and surface. The core solution or core composition is the solution that forms the bulk of, or all of, the initial particle nucleation, however as the particle forms and the “inner most core” and “interlayer” and “outer most layer” solution is mixed with the “core” solution, a gradient concentration in at least one of the metals is established within the growing particle to the point where the particle is nearly complete and the “interlayer” or “outer most layer” solution now form the bulk of, or all of, the final materials that deposit as part of the particle.

As used herein, the term “inner most core” of the particle, may refer to the region of the particle that is enclosed by the interlayer and outer most layer of the particle and has a vector radius (i.e. a directional radius measurement from a central portion to an outer portion) value that is lower than the interlayer and outer most layer. In other words, the center of the particle is valued at 0 radius and increases to a max value at the surface. The spatial location of inner most core, interlayer, and outer most layers are therefore values between 0 to max, where inner<inter<outer number values.

As used herein, the term “interlayer” of the particle, may refer to the region of the particle that is intermediate to the outer most layer and inner most core reaches of the particle and has a vector radius value that is in between the inner most core and outer most layer.

As used herein, the term “outer most layer” of the particle, may refer to the region of the particle that is nearing the outer most reaches of the particle and has a greater vector radius value than the interlayer and inner most core.

As used herein, a “spinel” structure refers to a class of minerals of general formulation AB₂X₄ that crystallize in the cubic crystal system, and may crystallize Fd-3m space group, or other space group. Its phase or structure is determined in that the X anions (typically chalcogens, like oxygen and sulfur) are arranged in a cubic close-packed lattice and the cations A and B occupying some or all of the octahedral and tetrahedral sites in the lattice.

As used herein, a “Mn-rich” structure refers to a class of minerals of general formulation αLi₂MnO₃·(1−α)LiNiₓMn_{y}Co_{1-x-y}O₂, 0<α<1, 0.333≤x≤1, and 0≤y≤0.5, wherein the Li₂MnO₃ crystallizes C2/m space group or other space group; and LiNiₓMn_{y}Co_{1-x-y}O₂ crystallizes in R-3m space group, or other space group.

As used herein, a “rock salt” structure refers to a class of materials which crystallize in the cubic space system and may crystallize in Fm-3m space group, and other space groups. Its phase or structure is determined in that each of the two atom types forms a separate face-centered cubic lattice, with the two lattices interpenetrating so as to form a 3D checkerboard pattern. A “disorder rock salt” structure refers to a rock salt structure with structure defects that include cation vacancy, anion vacancy, and cation mixing.

To improve the energy density and enhance the high-voltage functionality of layered oxide cathodes, a new strategy is provided for protecting the cathode materials from surficial side reactions and morphology damage, while simultaneously delivering high capacity. A cathode active material for such layered materials may be expressed by the following formulae:

[Li_{1+γ}(NiₓMn_{y}Co_{z})_{1-γ}O₂]_{α}^{M1}[Li_{1+δ}(Ni_{x′}Mn_{y′}Co_{z′})_{1-δ}O₂]_{β}^{M2}[Li_{1+ε}(Ni_{x″}Mn_{y″}Co_{z″})_{1-ε}O₂]_{1-α-β}^{M3}; or

[Na_{1+γ}(NiₓMn_{y}Co_{z})_{1-γ}O₂]_{α}^{M1}[Na_{1+δ}(Ni_{x′}Mn_{y′}Co_{z′})_{1-δ}O₂]_{β}^{M2}[Na_{1+ε}(Ni_{x″}Mn_{y″}Co_{z″})_{1-ε}O₂]_{1-α-β}^{M3}.

In the above formulae, 0≤α<1, 0<β<1, −0.1≤γ≤0.1, −0.3≤δ≤0.3, −0.5≤ε≤0.5, 0≤x≤1, 0≤y≤0.5, 0≤z≤1, 0≤x′≤0.5, 0.5≤y′≤1, 0≤z′≤0.5, and 0≤x″≤1, 0≤y″≤1, 0≤z″≤1; and the sum of x, y and z is 1, the sum of x′, y′ and z′ is 1, and the sum of x″, y″, and z″ is 1. In some embodiments, 0.8≤α<1, 0≤β<0.2, 0.6≤x≤1, 0≤y≤0.4, 0≤z≤0.4, 0≤x′≤0.5, 0.5≤y′≤1, 0≤z′≤0.4, 0≤x″≤0.4, 0.5≤y″≤1, and 0≤z″≤0.4. In other embodiments, 0.9≤α<1, 0≤β<0.1, 0≤x≤0.2, 0.8≤y≤1, 0≤z≤0.2, 0≤x′≤0.5, 0.5≤y′≤1, 0.5≤z′≤1, 0≤x″≤0.2, 0.5≤y″≤1, and 0≤z″≤0.2. In other embodiments, M2 or M3 comprises about 60 mol % to about 90 mol % of Mn.

In the above formulae, M1 is a structure having a layered phase, M2 has structure comprising a Mn-rich and/or spinel phase, M3 has a rock salt or disordered rock salt phase, and M1, M2, and M3 have different formulae. In the particles, an inner most core portion of the particle may be of a group of M1, M2, or M3, an interlayer may be any one of the remaining two of the group, and an outer most layer may be the remaining member of the group. In any of the above embodiments, the particle includes M1 as the inner most core, M2 as the interlayer, and M3 as the outer most layer. In other embodiments, the particle includes M2 as the inner most core, M3 as the interlayer, and M3 as the outer most layer.

In some embodiments, a cathode material is expressed as a composite structure of as [Li_{1+γ}(NiₓMn_{y}Co_{z})_{1-γ}O₂]_{α}^{M1}[Li_{1+δ}(Ni_{x′}Mn_{y′}Co_{z′})_{1-δ}O₂]_{β}^{M2}[Li_{1+ε}(Ni_{x″}Mn_{y″}Co_{z″})_{1-ε}O₂]_{1-α-β}^{M3} or as [Na_{1+γ}(NiₓMn_{y}Co_{z})_{1-γ}O₂]_{α}^{M1}[Na_{1+δ}(Ni_{x′}Mn_{y′}Co_{z′})_{1-δ}O₂]_{β}^{M2}[Na_{1+ε}(Ni_{x″}Mn_{y″}Co_{z″})_{1-ε}O₂]_{1-α-β}^{M3}, wherein: M1 represents an inner most core composition comprising of Ni, Mn, and/or Co or a combination at least two thereof, the structure of M1 may be structure that includes a layered phase; M2 represents an interlayer composition comprising of at least 50 mol % Mn, and optionally Ni and/or Co; the structure of M2 may be a structure comprising a Mn-rich phase or spinel phase; M3 represents an outer most layer comprising of at least 50 mol % Mn, and where the amount of Mn is less than 100 mol % Mn, the outer most layer may include Co, Ni, or a mixture thereof; the structure of M3 may be a rock salt or disordered rock salt phase; 0≤α<1, 0<β<1, −0.1≤γ≤0.1, −0.3≤δ≤0.3, −0.5≤ε≤0.5, 0≤x≤1, 0≤y≤0.5, 0≤z≤1, 0≤x′≤0.5, 0.5≤y′≤1, 0≤z′≤0.5, and 0≤x″≤1, 0≤y″≤1, 0≤z″≤1; and the sum of x, y and z is 1, the sum of x′, y′ and z′ is 1, and the sum of x″, y″, and z″ is 1. The arrangement of M1, M2, and M3 can be switched so that various combinations of inner most core, interlayer, and outer most layers consisting of the multiple structures and order of M1, M2, and M3 can be synthesized.

In general, when the cathode is characterized by a Ni-rich component, the Ni concentration is constant in the inner most core and then decreases in nearer the surface of the particle, the Mn concentration is constant and then increases nearer the surface of the particle, and the Co concentration is constant and then increases/decreases nearer the surface of the particle. When the cathode is characterized by a Mn-rich component, the Mn concentration is constant or partly/continuously decreased from particle center (i.e. inner most core) to the surface (i.e. outer most layer), the Ni concentration is constant or partly/continuously increases nearer the surface of the particle, and the Co concentration continuously decreases/increases toward the surface of the particle. In general, the sum of x, y, and z will be about 1, the sum of x′, y′, and z′ will be about 1, and the sum of x″, y″, and z″ will be about 1, however, lithium rich, lithium deficient, and rock salt or disordered rock salt structures may provide a wider range for these sums.

In some embodiments, the Mn is present at about 70 mol % at or near the surface of the particle. The cathode material is characterized by a concentration of M1 that is constant or partly/continuously decreased along a vector radius of the particle and where the concentration of M2 and M3 continuously increases along the vector radius. The cathode material is characterized in that the structure of M2 is composed of at least Mn-rich structure and may include a layered structure and a spinel structure, wherein the structure may gradually change in morphology from a layered structure toward the center of the particle to a Mn-rich interlayer. The outer most layer is characterized by the structure of M3 that is composed of rock salt or disordered rock salt phases. The rock salt or disordered rock salt phase may crystallize in the Fm-3m space group and other space groups, the layered structure may crystallize in the R-3m space group, and Mn-rich structure may crystallize in the C2/m space group and other space groups, and the spinel structure may crystallize in the Fd-3m space group and other space groups.

The outer layer of the particle is the smallest and includes the least amount of material when compared to the inner most core and any interlayers between the core and outer most layer. The outer layer may be from greater than 0.001 to 2 μm in thickness. This may include from 0.001 to 0.5 μm, from 1 to 100 nm, from 1 to 50 nm, or from 1 to 20 nm.

In any of the embodiments, herein each particle exhibits a generally spherical morphology and having a radius vector defined directionally from an inner portion of the particle to an outer portion.

The composition may have greater than 50% by weight Ni, and the Ni concentration is constant or partly/continuously decreased from particle center to surface, the Co concentration is constant or partly/continuously decreases or increases nearer the surface of the particle, and the Mn concentration partly/continuously increases toward the surface of the particle. In other embodiments, the composition may have greater than 50% by weight Mn, and the Mn concentration is constant or partly/continuously decreased from particle center to surface, the Co concentration is constant or partly/continuously decreases or increases nearer the surface of the particle, and the Ni concentration partly/continuously increases toward the surface of the particle.

It is noted that in any of the embodiments herein, a concentration of Ni, Mn, and/or Co in any of M1, M2, and M3 changes by one or more slopes. By “slopes” it is understood that the rate in change of concentration may not be constant, such that if the concentration of any particular metal were graphed from the center of the particle to the surface it would be a single sloping curve for the concentration, but rather the rate of change of the concentration may change such that the graph would have more than a single sloping curve for any particular metal.

Additional interlayers, MX, may also be incorporated into the particles, where X is an integer greater than 3. For example, the structure may contain an interlayer M4, such that the formula may be illustrated as (M1)(M2)(M4)(M3), where M3 is the surface, M1 is the core, and M2 is a first interlayer. Additional interlayers, M5, M6, M7, etc. may also be included.

Accordingly, in another aspect, cathode active material includes a composition expressed as:

[Li_{1+γ}(NiₓMn_{y}Co_{z})_{1-γ}O₂]_{α}^{M1}[Li_{1+δ}(Ni_{x′}Mn_{y′}Co_{z′})_{1-δ}O₂]_{β}^{M2}[Li_{1+ε}(Ni_{x″}Mn_{y″}Co_{z″})_{1-ε}O₂]_{φ}^{M3}[Li_{1+μ}(Ni_{x′″}Mn_{y′″}Co_{z′″})_{1-μ}O₂]_{1-α-β-φ}^{MX}; or

[Na_{1+γ}(NiₓMn_{y}Co_{z})_{1-γ}O₂]_{α}^{M1}[Na_{1+δ}(Ni_{x′}Mn_{y′}Co_{z′})_{1-δ}O₂]_{β}^{M2}[Na_{1+ε}(Ni_{x″}Mn_{y″}Co_{z″})_{1-ε}O₂]_{φ}^{M3}[Na_{1+μ}(Ni_{x′″}Mn_{y′″}Co_{z′″})_{1-μ}O₂]_{1-α-β-φ}^{MX}.

In such formulas, M1 is a structure comprising a layered phase; M2 is a structure comprising a Mn-rich and/or spinel phase; M3 is a structure comprising a rock-salt or disordered rock-salt phase; MX is a composite structure comprising a layered, Mn-rich, and/or spinel, or rock salt and/or disordered rock salt phase; MX is absent or present and when present represents additional layers where X is greater than 3. In the formulas, 0≤α<1, 0<β<1, 0<φ<1, −0.1≤γ≤0.1, −0.3≤δ≤0.3, −0.5≤ε≤0.5, −0.7≤μ≤0.7, 0≤x≤1, 0≤y≤0.5, 0≤z≤1, 0≤x′≤0.5, 0.5≤y′≤1, 0≤z′≤0.5, 0≤x″≤1, 0≤y″≤1, 0≤z″≤1, and 0≤x′″≤1, 0≤y′″≤1, and 0≤z′″≤1; and the sum of x, y and z is 1, the sum of x′, y′ and z′ is 1, the sum of x″, y″, and z″ is 1, and the sum of x′″, y′″, and z′″ is 1.

In some embodiments, the cathode material represents a Ni-rich component expressed by [Li_{1+γ}(NiₓMn_{y}Co_{z})_{1-γ}O₂]_{α}^{M1}[Li_{1+δ}(Ni_{x′}Mn_{y′}Co_{z′})_{1-δ}O₂]_{β}^{M2}[Li_{1+ε}(Ni_{x″}Mn_{y″}Co_{z″})_{1-ε}O₂]_{1-α-β}^{M3}, wherein: M1 represents a inner most core composition including Ni, Mn, Co, or a combination of any two or more thereof; the structure of M1 may include a layered phase; M2 represents an interlayer composition including 50 mol % or greater Mn, and optionally Ni and/or Co; the structure of M2 may be a Mn-rich phase or spinel phase; M3 represents an outer most layer include 50 mol % or greater Mn, and where the amount of Mn is less than 100 mol % Mn, the outer most layer may include Co, Ni, or a mixture thereof; the structure of M3 may be a rock salt or disordered rock salt phase; 0≤α<1, 0<β<1, −0.1≤y≤0.1, −0.3≤δ≤0.3, −0.5≤ε≤0.5, 0≤x≤1, 0≤y≤0.5, 0≤z≤1, 0≤x′≤0.5, 0.5≤y′≤1, 0≤z′≤0.5, and 0≤x″≤1, 0≤y″≤1, 0≤z″≤1; and the sum of x, y and z is 1, the sum of x′, y′ and z′ is 1, and the sum of x″, y″, and z″ is 1. In some embodiments, γ is 0, δ is 0, or ε is 0. In some embodiments, the Mn is present at about 70 mol % at or near the surface of the particle. In any embodiments, the Ni concentration constant or partly/continuously decreased from particle center to surface, the Co concentration is constant or partly/continuously decreases nearer the surface of the particle, and the Mn concentration partly/continuously increases toward the surface of the particle. The cathode material may be characterized in that the structure of M2 is composed of at least a Mn-rich phase and may include a layered structure and/or a spinel structure, and where M3 is composed of at least a rock salt phase and may include a layered structure and/or a spinel structure.

In some embodiments, the cathode material represents a Mn-rich component expressed as [Li_{1+γ}(NiₓMn_{y}Co_{z})_{1-γ}O₂]_{α}^{M2}[Li_{1+δ}(Ni_{x′}Mn_{y′}Co_{z′})_{1-δ}O₂]β^{M1}[Li_{1+ε}(Ni_{x″}Mn_{y″}Co_{z″})_{1-ε}O₂]_{1-α-β}^{M3}, wherein: M1 represents a interlayer composition comprising of Ni, Mn, Co, or a combination of two or more thereof, the structure of M1 may include a layered phase; M2 represents an inner most core composition of 50 mol % or greater Mn, and optionally Ni and/or Co; the structure of M2 may include a Mn-rich phase or spinel phase; M3 represents an outer most layer 50 mol % or greater Mn, and where the amount of Mn is less than 100 mol % Mn, the outer most layer may include Co, Ni, or a mixture thereof; the structure of M3 may be of a rock salt or disordered rock salt phase; 0≤α<1, 0<β<1, −0.3≤γ≤0.3, −0.1≤δ≤0.1, −0.5≤ε≤0.5, 0≤x≤0.5, 0.5≤y≤1, 0≤z≤0.5, 0≤x′≤1, 0≤y′≤0.5, 0≤z′≤1, and 0≤x″≤1, 0≤y″≤1, 0≤z″≤1; and the sum of x, y and z is 1, the sum of x′, y′ and z′ is 1, and the sum of x″, y″, and z″ is 1. In some embodiments, the Ni is present at about 70 mol % at or near the surface of the particle. The Mn concentration is constant or partly/continuously decreased from particle center to surface, the Co concentration is constant or partly/continuously decreases/or increases nearer the surface of the particle, and the Ni concentration continuously increases toward the surface of the particle. The cathode material may be characterized in that the interlayer M1 structure is composed of at least a layered structure, M2 inner most core composition is composed of at least a Mn-rich structure and may include a layered structure and/or a spinel structure, and the outer most layer of M3 is composed of at least a rock salt or disordered rock salt phase and may include a layered structure and/or a spinel structure.

In any embodiments, the surface composition includes more than 50 mol % Mn, and gradually increases going toward the surface. In some embodiments, the surface composition includes more than about 60 mol % Mn. In some embodiments, the surface composition includes more than about 70 mol % Mn. In some embodiments, the surface composition includes from about 60 mol % to about 75 mol % Mn. In any of the above embodiments, the interlayer structure may include Mn-rich and/or spinel phase, and the outer most layer surface structure may include a rock salt or disordered rock salt phase.

In any embodiments, where the concentration of M1 or M2 in the gradient cathode decreases, it could be through one slope or more (i.e. one or more concentration rate changes). Where the concentration of M2 or M3 increases in the gradient cathode, it could be using one slope or more.

The cathode materials may further include a dopant cation, T or T′, such that the overall formula may be expressed as [Li_{1+γ}(NiₓMn_{y}Co_{z}T_{ζ})_{1-γ}O₂]_{α}^{M1}[Li_{1+δ}(Ni_{x′}Mn_{y′}Co_{z′}T′_{η})_{1-δ}O₂]_{β}^{M2}[Li_{1+ε}(Ni_{x″}Mn_{y″}Co_{z″}T″_{θ})_{1-ε}O₂]_{1-α-β}^{M3} or as [Na_{1+γ}(NiₓMn_{y}Co_{z}T_{ζ})_{1-γ}O₂]_{α}^{M1}[Na_{1+δ}(Ni_{x′}Mn_{y′}Co_{z′}T′_{η})_{1-δ}O₂]_{β}^{M2}[Na_{1+ε}(Ni_{x″}Mn_{y″}Co_{z″}T″_{θ})_{1-ε}O₂]_{1-α-β}^{M3}, where T, T′, and T″ are an alkaline earth metal or a transition metal other than Ni, Mn, and Co, or a combination of any two or more thereof, where; 0≤ζ≤0.1, 0≤η≤0.1, 0≤θ≤0.1, 0≤α<1, 0<β<1, −0.1≤γ≤0.1, −0.3≤δ≤0.3, −0.5≤ε≤0.5, 0≤x≤1, 0≤y≤0.5, 0≤z≤1, 0≤x′≤0.5, 0.5≤y′≤1, 0≤z′≤0.5, and 0≤x″≤1, 0≤y″≤1, 0≤z″≤1; and the sum of x, y and z is 1, the sum of x′, y′ and z′ is 1, and the sum of x″, y″, and z″ is 1. The dopant may, in some embodiments, be Ca, Ti, Cr, V, Fe, Cu, Zn, Zr, Nb, Mo, Ru, Ir, La, W, Sn, Sb, or a mixture of any two or more thereof. These dopant may be present in a constant concentration along the vector radius of the particle (i.e. particle doping), or be present only at the surface of the particle (i.e. surface doping).

The cathode materials may include coating layer over/around the particle. Illustrative coating materials include, a metal oxide such as MgO, Al₂O₃, ZrO₂, MnO₂, CeO₂, TiO₂, ZnO, SiO₂, SnO₂, or Cr₂O₃; a metal fluoride such as AlF₃, CaF₂, CeF₃, ZrF, ZrF₂, ZrF₃, ZrF₄, LaF₃, or SrF₂; a metal phosphate such as Li₃PO₄, AlPO₄, YPO₄, Li₃PO₄, FePO₄, Mg₃(PO₄)₂, Zn₃(PO₄)₂, Ca₃(PO₄)₂, Co₃(PO₄)₂, or Ni₃(PO₄)₂; a conductive carbon coating based upon polyacetylenes, polypyrroles, polyparaphenylenes, polythiophene, polyfurans, polythianaphthenes, polyanilines, poly(3,4-ethylenedioxythiophene) (“PEDOT”) and their derivatives or copolymers; or a combination of any two or more thereof.

In other aspect, an electrochemical device is provided that includes the cathode active materials as described above. In some embodiments, the electrochemical device may be a lithium ion battery or a sodium ion battery. Such batteries include a cathode including the cathode active materials, an anode, a separator existing between the cathode and anode, and an electrolyte, which is immersed in the cathode, the anode, and the separator.

Illustrative anode materials are those that can reversibly absorb or release lithium or sodium ions. The materials may include artificial graphite, natural graphite, and graphitized carbon fiber amorphous carbon. Lithium metal also can be used as an anode active material. The electrolyte may be a liquid electrolyte containing a lithium salt, a non-aqueous organic solvent, and/or a polymer gel.

In a further aspect, a process of preparing a cathode active material is provided that includes providing a first aqueous metal ion solution; providing a second aqueous metal ion solution; providing a third aqueous metal ion solution; optionally, providing additional aqueous metal ion solutions X where X>3; combining the first, second, third, and, optionally additional metal solutions with a precipitating agent to form a precipitate; isolating the precipitate; mixing the precipitate with a lithium or sodium salt to form a mixture; and heating-treating the mixture to form the cathode active material that is expressed as:

[Li_{1+γ}(NiₓMn_{y}Co_{z})_{1-γ}O₂]_{α}^{M1}[Li_{1+δ}(Ni_{x′}Mn_{y′}Co_{z′})_{1-δ}O₂]_{β}^{M2}[Li_{1+ε}(Ni_{x″}Mn_{y″}Co_{z″})_{1-ε}O₂]_{1-α-β}^{M3}; or

[Na_{1+γ}(NiₓMn_{y}Co_{z})_{1-γ}O₂]_{α}^{M1}[Na_{1+δ}(Ni_{x′}Mn_{y′}Co_{z′})_{1-δ}O₂]_{β}^{M2}[Na_{1+ε}(Ni_{x″}Mn_{y″}Co_{z″})_{1-ε}O₂]_{1-α-β}^{M3};

wherein: M1 represents a structure having a layered phase; M2 represents a structure having a Mn-rich and/or spinel phase; M3 represents a structure having a rock-salt or disordered rock-salt phase; 0≤α<1, 0<β<1, −0.1≤γ≤0.1, −0.3≤δ≤0.3, −0.5≤ε≤0.5, 0≤x≤1, 0≤y≤0.5, 0≤z≤1, 0≤x′≤0.5, 0.5≤y′≤1, 0≤z′≤0.5, and 0≤x″≤1, 0≤y″≤1, 0≤z″≤1; and the sum of x, y, and z is 1, the sum of x′, y′, and z′ is 1, and the sum of x″, y″, and z″ is 1. As noted above, M1, M2, and M3 may be any layer of the structure. In some embodiments, M1 is the inner most core, M2 is an interlayer, M3 is a outer most layer, and MX is optional additional interlayers. In other embodiments, M2 is the inner most core, M1 is an interlayer, M3 is an outer most layer, and MX is optional additional interlayers.

In such a process, M1 and/or M2 and/or M3 are established in particles of the precipitate along a vector radius defined from the center of the particle to the surface; a concentration gradient of Ni, Mn, and Co of M1, M2, and M3 is established in particles of the precipitate along a vector radius defined from the center of the particle to the surface. The process may also include heat-treating as calcination at a temperature of about 680° C. to about 1200° C., where the calcination step is conducted in an oxygen atmosphere, an air atmosphere, or in an oxygen-enriched air atmosphere.

In another aspect, provided are methods for preparing the cathode materials. Generally, the methods include preparation of the core, interlayer, and outer most surface solutions. The materials are then introduced to a reactor where, by adjusting flow rates, the particles with a gradient concentration of the metals as described above, may be formed as precursor materials by precipitating from the core and/or surface solutions with the addition of a precipitating agent and a chelating agent. By way of further explanation, first, M1 and M2 and M3 solutions, or MX solutions where X>3 as needed, are prepared for inner most core composition solution and the interlayer and outer most layer solution, respectively. The inner most core solution may contain an appropriate ratio of Ni, Mn and Co; and the surface solution contains at least 50 mol % Mn, and may contain Ni and/or Co as well. The M1 solution for the inner most core, the M2 interlayer solution, and M3 outer most layer solution for the surface may be prepared by adding a nickel salt, cobalt salt, and manganese salt to a solvent, or they may be prepared by preparing aqueous solution containing the nickel salt, cobalt salt, and manganese salt, respectively followed by mixing. The M1, M2, and M3 or MX solutions may be prepared using a salt of oxalic acid, nitric acid, sulfuric acid, hydrochloric acid, or a combination of thereof, which can be dissolved in water or other solvents, without particular limitation. The concentrations of M1, M2, and M3 or MX may be the same or different from 0.1 M to 10.0 M. This concentration range includes 0.1 M, 0.2 M, 0.3 M, 0.4 M, 0.5 M, 1.0 M, 1.5 M, 2.0 M, 2.5 M, 3.0 M, 3.5 M, 4.0 M, 4.5 M, 5.0 M, 6 M, 7 M, 8 M, 9 M, 10 M and the appropriate ratio within this range. The solutions, in two different tanks, are pumped to a reactor by appropriate time and proportion, wherein a chelating agent and metal salt solution are added by the appropriate proportion, a precipitant agent is pumped into the reactor simultaneously to obtain a precipitate with a part or continuous gradient concentration. The precipitate so produced is referred to as the “precursor,” because it will then be mixed with a lithium or sodium source, heat-treated to form the oxides, and the oxides are then recovered as the cathode active material. The gradient concentration refers to the fact that two or more elements exhibit concentration changes in part/whole along a vector radius of the particle.

Illustrative chelating agents include, but are not limited to, an ammonia salt or a salt containing ammonium ions such as ammonium sulfate or ammonium nitrate, or a combination of thereof. The concentration of chelating agent may vary from 0.1 M to 10 M. This includes concentrations of about 0.5 M, 1.0 M, 1.5 M, 2.0 M, 2.5 M, 3.0 M, 3.5 M, 4.0 M, 4.5 M, 5.0 M, 6.0 M, 7.0 M, 8.0 M, 9.0 M, 10 M, and the appropriate amounts within these ranges. A ratio of chelating agent to transition metal solution, on a mol basis, may also vary from 0.1 to 5, and may be 0.1, 0.2, 0.3, 0.4, 0.5, 0.6, 0.7, 0.8, 0.9, 1, 1.5, 2, 2.5, 3, 3.5, 4, 4.5, 5, or an appropriate concentration within this range.

Illustrative precipitating agents include, but are not limited to, sodium hydroxide, sodium carbonate, and sodium oxalate. A concentration of precipitant agent in the solution to be added may vary from about 0.1 M to about 10 M. This may include concentrations of about 0.5 M, 1.0 M, 1.5 M, 2.0 M, 2.5 M, 3.0 M, 3.5 M, 4.0 M, 4.5 M, 5.0 M, 6.0 M, 7.0 M, 8.0 M, 9.0 M, 10 M, or an appropriate concentration within this range. The precipitating agent in the reactor may be controlled by pH, and the pH may be from about 9 to about 12, defined at room temperature. The pH, in various embodiments, may be 9.0, 9.5, 10.0, 10.5, 11.0, 11.5, 12.0, or an appropriate value within this range.

After synthesis, the precipitate is washed and dried and may be stored under an atmosphere of a protective gas before being heat treated to form the cathode active material. Illustrative protective gases include, but are not limited to, N₂, He, Ar, Xe, and Kr.

Thus, in some embodiments, the method of forming the particles includes mixing a precursor and a lithium salt or a sodium salt in an appropriate ratio, and heat-treating at a temperature of about 300° C. to about 1200° C. The precursor refers to a hydroxide or carbonate ((NiₐMn_{b}Co_{c})(OH)_{2+d} or (NiₐMn_{b}Co_{c})CO₃) containing a suitable proportion of Ni, Mn, and Co that can be converted to LiNiₐMn_{b}Co_{c}O₂ when reacting with Li and followed by heat treating (i.e. a calcination as in other preparative procedures for lithium nickel manganese cobalt oxides. Illustrative lithium salts include, but are not limited to, LiOH, Li₂CO₃, LiNO₃, LiCl, LiF, LiBr, LiI, Li₂O, or a mixture of any two or more thereof. Illustrative sodium salts include, but are not limited to, NaOH, Na₂CO₃, NaNO₃, NaCl, NaF, NaBr, NaI, Na₂O, or a mixture of any two or more thereof. A ratio of the lithium or sodium salt and the metal of the precursor may vary from about 0.9 to about 1.1 on a mol basis. This may include values of about 0.9, 0.91, 0.92, 0.93, 0.94, 0.95, 0.96, 0.97, 0.98, 0.99, 1.00, 1.01, 1.02, 1.03, 1.04, 1.05, 1.06, 1.07, 1.08, 1.09, 1.10, and appropriate ratios within this range. The heat-treating may include pre-sintering at the temperature of about 300° C. to about 600° C., maintaining this temperature for about 2 to about 10 hours, and then sintering at about 680° C. to about 1200° C. for about 5 to about 30 hours. The sintering atmosphere may be selected from oxygen, air, or a combination of thereof.

The present invention, thus generally described, will be understood more readily by reference to the following examples, which are provided by way of illustration and are not intended to be limiting of the present invention.

### Examples

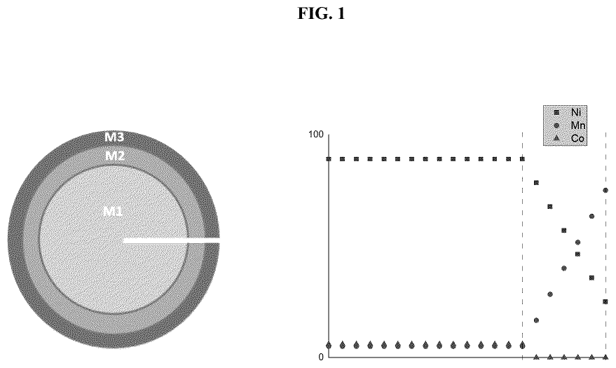

Example 1. FIG. 1. illustrates a transition metal component schematic of a cathode active material that may be expressed as [Li_{1+γ}(NiₓMn_{y}Co_{z})_{1-γ}O₂]_{α}^{M1}[Li_{1+δ}(Ni_{x′}Mn_{y′}Co_{z′})_{1-δ}O₂]_{β}^{M2}[Li_{1+ε}(Ni_{x″}Mn_{y″}Co_{z″})_{1-ε}O₂]_{1-α-β}^{M3}, as described above. The Ni concentration is constantly or partly/continuously decreased from particle center to surface, the Mn concentration is constant or partly/continuously increases nearer the surface of the particle, and the Co concentration partly/continuously increases/decreases toward the surface of the particle. The cathode material is characterized in that the structure of M2 is composed of a Mn-rich that may also include a layered structure and/or a spinel structure, and M3 is composed of a rock salt or disordered rock salt phase that may also include a layered structure and/or a spinel structure, where the structure across the gradient becomes a rock salt or disordered rock salt phase near the surface. FIG. 1 depicts the inner most core component (M1) of the cathode as having a high Ni content, the interlayer and outer most layer surface component as having a high Mn content, wherein the core contains 50 mol % or greater Ni that may contain Mn and Co; while the interlayer and outer most layer component contains 50 mol % or greater Mn and which may contain Ni and Co. The outer most layer surface of the particles may also include the rock salt or disordered rock salt phase.

Example 2. The preparation of a cathode active material expressed as [Li_{1+γ}(NiₓMn_{y}Co_{z})_{1-γ}O₂]_{α}^{M1}[Li_{1+δ}(Ni_{x′}Mn_{y′}Co_{z′})_{1-δ}O₂]_{β}^{M2}[Li_{1+ε}(Ni_{x″}Mn_{y″}Co_{z″})_{1-ε}O₂]_{1-α-β}^{M3}, wherein: M1 represents an inner most core composition comprising of Ni, Mn, and/or Co or a combination at least two thereof, the structure of M1 may include a layered phase; M2 represents an interlayer composition comprising of at least 50 mol % Mn, and where the amount of Mn is less than 100 mol % Mn, the outer most layer may include Co, Ni, or a mixture thereof; the structure of M2 may include a Mn-rich phase or spinel phase; M3 represents an outer most layer comprising of at least 50 mol % Mn, and where the amount of Mn is less than 100 mol % Mn, the outer most layer may include Co, Ni, or a mixture thereof; the structure of M3 may be a structure comprising a rock salt or disordered rock salt phase; 0≤α<1, 0<β<1, −0.1≤γ≤0.1, −0.3≤δ≤0.3, −0.5≤ε≤0.5, 0≤x≤1, 0≤y≤0.5, 0≤z≤1, 0≤x′≤0.5, 0.5≤y′≤1, 0≤z′≤0.5, and 0≤x″≤1, 0≤y″≤1, 0≤z″≤1; and the sum of x, y and z is 1, the sum of x′, y′ and z′ is 1, and the sum of x″, y″, and z″ is 1. The cathode material is characterized by a Ni-rich component, the Ni concentration constant or partly/continuously decreased from particle center to surface, the Co concentration is constant or partly/continuously decreases/or increases nearer the surface of the particle, and the Mn concentration continuously increases toward the surface of the particle.

A representative of the Ni-rich [Li_{1+γ}(NiₓMn_{y}Co_{z})_{1-γ}O₂]_{α}^{M1}[Li_{1+δ}(Ni_{x′}Mn_{y′}Co_{z′})_{1-δ}O₂]_{β}^{M2}[Li_{1+ε}(Ni_{x″}Mn_{y″}Co_{z″})_{1-ε}O₂]_{1-α-β}^{M3} is described below. In a co-precipitation synthesis, the concentration gradient precursor was prepared from two metal solutions. The solution for preparing the core component contained Ni, Mn, and Co at a ratio of 89:5:6 on a mol basis. The solution for preparing the surface component contained Ni and Mn at a ratio of 25:75 on a mol basis. The concentration of two metal solutions was 2 M and was prepared with the corresponding sulfate salts of the metals. A volume ratio of the two metal solutions was 90:10, and the volume of two metal solutions in total was 1.0 L.

An initial chelating agent was prepared by mixing 1.2 L purified water and 300 ml of 5 M ammonia (aq) solution, and then placed into a co-precipitation reactor. The reaction temperature was set at 60° C., the rotation speed was set at 1000 rpm, and nitrogen gas was used as a purge and environmental gas for the synthetic process.

The aqueous metal solutions for the core and surface compositions mixed at a volume ratio of 90:10. The metal solution for the core was directly injected into a 4 L reactor at 0.04 L/hour, 5 M ammonia solution was continuously injected into the reactor at the rate of 0.02 L/hour. The content of the precipitant agent, NaOH, was controlled by pH value. A 5 M NaOH(aq) solution was supplied to maintain the pH in the reactor at 11. After consuming about 80% the core solution, the metal solution for the surface composition was injected into, and mixed with, the core solution at the rate of 0.04 L/hour. During the synthetic process, a stirring speed of the reactor was kept at 1000 rpm, and the reaction temperature was set at 60° C. The co-precipitation reaction was conducted for about 20 hours. Thereafter, the precipitant was maintained at the steady state for 4 hours to obtain a co-precipitated compound with higher density. The compound was then collected by filtration, washed with water, and dried at 110° C. with nitrogen gas for 15 hours to obtain a cathode material precursor.

The precursor was then mixed with lithium hydroxide at a wt ratio of 1:1.03, and then heated to 450° C. at a rate of 2° C./min, and finally maintained at 450° C. for 5 hours followed by calcining at 750° C. for 12 hours to obtain a final cathode material particle.

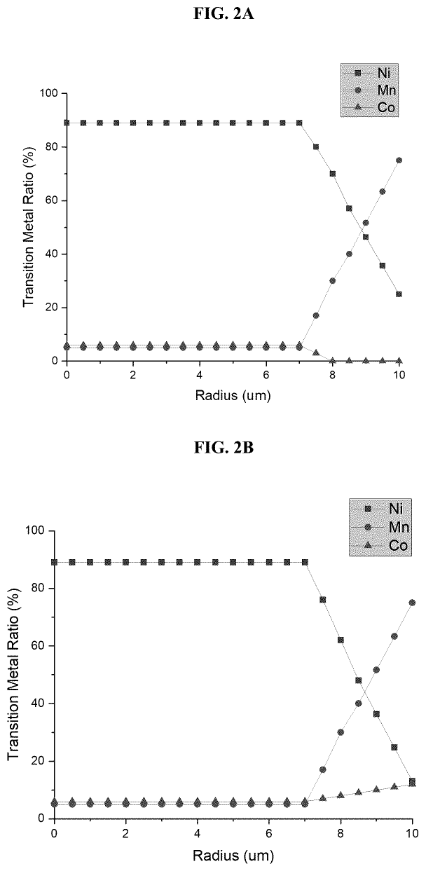

According to the synthetic process, a typical representative concentration of Example 2 is shown in FIG. 2. As shown, the Ni concentration is constant in the core portion and then quickly decreases to 25% at the surface; the Mn concentration is constant in the core part and then quickly increases to 75 mol % in the surface; and the Co concentration is constant in the core part and then decreases from 6 to 0% in the surface.

Example 3. A representative of the Ni-rich [Li_{1+γ}(NiₓMn_{y}Co_{z})_{1-γ}O₂]_{α}^{M1}[Li_{1+δ}(Ni_{x′}Mn_{y′}Co_{z′})_{1-δ}O₂]_{β}^{M2}[Li_{1+ε}(Ni_{x″}Mn_{y″}Co_{z″})_{1-ε}O₂]_{1-α-β}^{M3} with two-slope concentration gradient is described below. In a co-precipitation synthesis, the concentration gradient precursor was prepared by two metal solutions. The solution for preparing the core component contains Ni, Mn, and Co at a mol ratio of 92:2:6; and the solution for preparing the surface component contains Ni, Mn, and Co at a mol ratio of 20:75:5 the concentration of two metal solutions is 2 M and prepared with the corresponding sulfate salts; the volume ratio of two metal solutions is 80:20; and the volume of two metal solutions in total is 1.0 L.

The initial chelating agent is prepared by mixing 1.2 L purified water and 300 ml 5 M aqueous ammonia solution, and then placing it into a co-precipitation reactor. The reaction temperature was set at 60° C., the rotation speed was set at 1000 rpm, and nitrogen gas protection was applied to the process.

The metal aqueous solution for preparing the core and the metal aqueous solution for preparing the surface part were mixed at a volume ratio of 80:20. The metal solution for the core was directly injected into the 4 L reactor at 0.04 L/hour, and simultaneously the metal solution for surface was injected into the core solution at the rate of 0.005 L/hour. Further, a 5 M ammonia solution was continuously injected into the reactor at the rate of 0.02 L/hour. Further, the content of the precipitating agent, NaOH, was controlled by pH value. A 5 M NaOH aqueous solution was supplied to maintain pH in the reactor at 11. After consuming 50 vol % of the surface solution, the metal solution for surface part was injected into the core solution at the rate of 0.04 L/hour. In the synthetic process, the stirring speed of the reactor was kept at 1000 rpm, and the reaction temperature was set at 60° C. The co-precipitation reaction was conducted for about 20 hours, thereafter, the precipitant was kept at a steady state for 4 hours to obtain a co-precipitated compound with higher density. The compound was then filtered, washed with water, and dried with 110° C. with nitrogen gas for 15 hours to obtain a cathode active material precursor.

The precursor was mixed with lithium hydroxide at a mol ratio of 1:1.03, and then heated to 450° C. at a rate of 2° C./min, and then maintained at 450° C. for 5 hours followed by calcining at 750° C. for 12 hours to obtain a final cathode material particle.

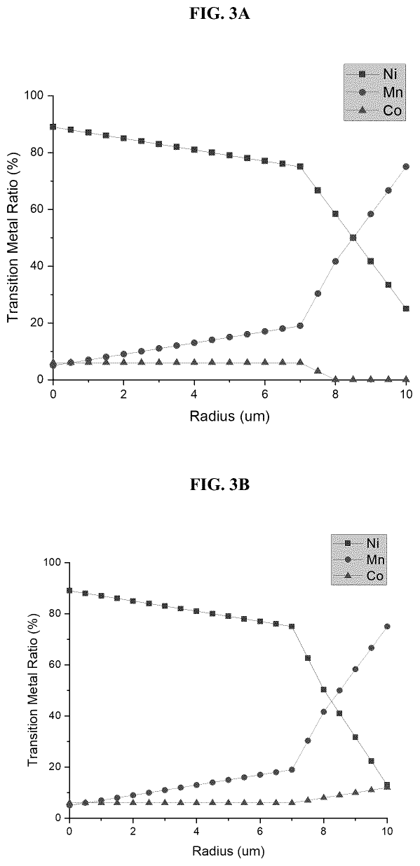

According to the synthetic process, a typical representative concentration of Example 2 is shown in FIG. 3A and FIG. 3B. The Ni concentration slowly decreases in the core and then quickly decreases to 25% (3A) or 13% (3B) at the surface; the Mn concentration slowly increases in the core part and then quickly increases to 75 mol % in the surface; and the Co concentration slowly decreases to 0% (3A) or increases in the core part and then sharply increases to 12 mol % (3B) in the surface.

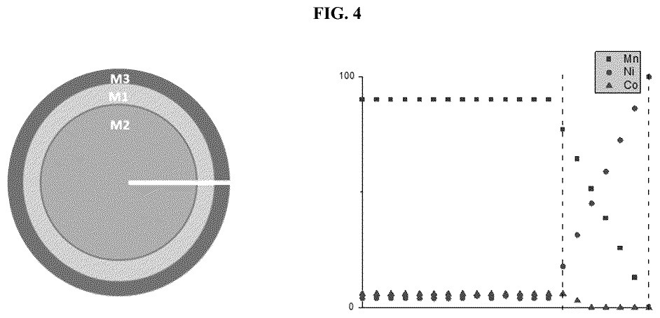

Example 4. FIG. 4 depicts a transition metal component schematic of the cathode material expressed as [Li_{1+γ}(NiₓMn_{y}Co_{z})_{1-γ}O₂]_{α}^{M2}[Li_{1+δ}(Ni_{x′}Mn_{y′}Co_{z′})_{1-δ}O₂]_{β}^{M1}[Li_{1+ε}(Ni_{x″}Mn_{y″}Co_{z″})_{1-ε}O₂]_{1-α-β}^{M3}, wherein: M1 represents an interlayer composition comprising of Ni, Mn, and/or Co or a combination at least two thereof; the structure of M1 may include a layered phase; M2 represents an inner most core composition comprising of at least 50 mol % Mn, and optionally Ni and/or Co; the structure of M2 may include a Mn-rich phase or spinel phase; M3 represents an outer most layer comprising of at least 50 mol % Mn, and where the amount of Mn is less than 100 mol % Mn, the outer most layer may include Co, Ni, or a mixture thereof; the structure of M3 may include a rock salt or disordered rock salt phase; 0≤α<1, 0<β<1, −0.3≤γ≤0.3, −0.1≤δ≤0.1, −0.5≤ε≤0.5, 0≤x≤0.5, 0.5≤y≤1, 0≤z≤0.5, 0≤x′≤1, 0≤y′≤0.5, 0≤z′≤1, and 0≤x″≤1, 0≤y″≤1, 0≤z″≤1; and the sum of x, y and z is 1, the sum of x′, y′ and z′ is 1, and the sum of x″, y″, and z″ is 1. The cathode is characterized by a Mn-rich component in general; The Mn concentration is constant or partly/continuously decreased from particle center to surface, the Co concentration is constant or partly/continuously decreases/or increases nearer the surface of the particle, and the Ni concentration continuously increases toward the surface of the particle.

A representative example of the Mn-rich [Li_{1+γ}(NiₓMn_{y}Co_{z})_{1-γ}O₂]_{α}^{M1}[Li_{1+δ}(Ni_{x′}Mn_{y′}Co_{z′})_{1-δ}O₂]_{β}^{M2}[Li_{1+ε}(Ni_{x″}Mn_{y″}Co_{z″})_{1-ε}O₂]_{1-α-β}^{M3} is described below. In a co-precipitation synthetic method, the concentration gradient precursor was prepared from two metal solutions. The solution for preparing the core component contains Mn and Ni at a mol ratio of 98:2; and the solution for preparing the surface component contains Ni and Mn at a mol ratio of 70:30; the concentration of the two metal solutions was 2 M and prepared with the corresponding sulfate salt; where the volume ratio of the two metal solutions is 90:10, and the volume of two metal solutions in total was 1.0 L.

The initial chelating agent was prepared by mixing 1.2 L purified water and 300 ml 5 M aqueous ammonia solution, and then charged to a co-precipitation reactor. The reaction temperature was set at 60° C., the rotation speed was set at 1000 rpm, and nitrogen gas protection was applied to the process.

The aqueous metal solutions for preparing the core and surface compositions were mixed in a volume ratio of 90:10. The metal solution for the core was directly injected into the 4 L reactor at 0.04 L/hour, and 5 M ammonia solution was continuously injected into the reactor at the rate of 0.02 L/hour. Further, the precipitating agent, NaOH, was controlled by pH value. A 5 M NaOH aqueous solution was supplied to maintain the pH in the reactor at 11. After consuming 80 vol % of the core solution, the metal solution for the surface composition was initiated into the reactor and mixed with the core solution at the rate of 0.04 L/hour. In the synthetic process, the stirring speed of the reactor was kept at 1000 rpm, and the reaction temperature was set at 60° C. The co-precipitation reaction was conducted around 20 hours; afterward, the precipitant was maintained at steady state for 4 hours to obtain a co-precipitated compound with higher density. The compound was then filtered, washed with water, and dried at 110° C. with nitrogen gas for 15 hours to obtain a cathode active material precursor.

The precursor was mixed with lithium hydroxide at a mol ratio of 1:1.03, and then heated to 500° C. at a rate of 2° C./min, and then maintained at 450° C. for 5 hours followed by calcining at 900° C. for 12 hours to obtain a final cathode material particle.

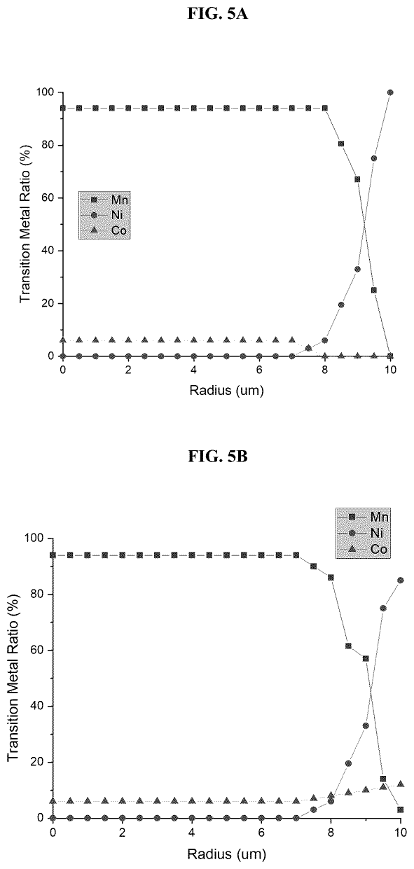

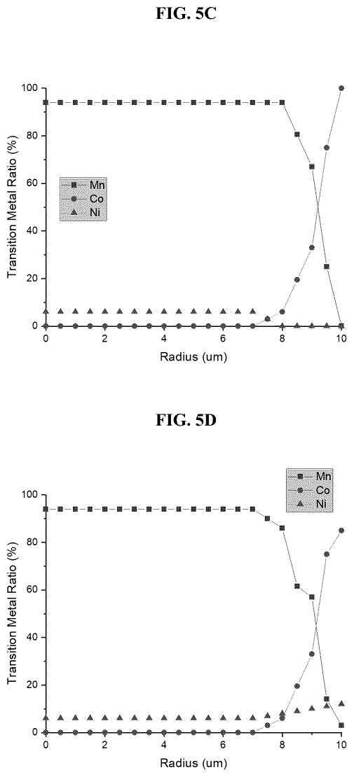

According to the synthesis process, a typical representative concentration of Example 4 is shown in FIGS. 5A and 5B. The Mn concentration was constant in the core and then quickly decreased to 0 mol % at the surface; the Co concentration is constant in the core part and then quickly decreased to 0% (FIG. 5A) or increased to 12 mol % (FIG. 5B) at the surface; and the Ni concentration is constant in the core part and then increased from 5 mol % to 100 mol % (FIG. 5A) or 88% (FIG. 5B) at the surface. FIGS. 5C and 5D also show a typical representative concentration of Example 4, where the Mn concentration was constant in the core and then quickly decreased to 0 mol % at the surface; the Ni concentration is constant in the core part and then quickly decreased to 0% (FIG. 5C) or increased to 12 mol % (FIG. 5D) at the surface; and the Co concentration is constant in the core and then increased from 5 mol % to 100 mol % (FIG. 5C) or 88% (FIG. 5D) at the surface.

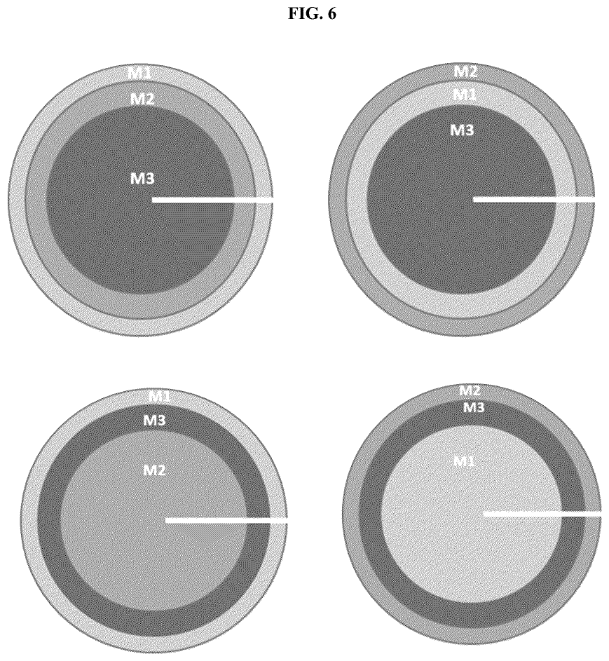

Example 5. FIG. 6 shows the remaining possible combinations for the multi-structure design where M3 can act as the inner most core or the interlayer. In either configuration, M1 and M2 are exchangeable and can both act as the remaining outer most layer, interlayer, or inner most core. M1, M2, and M3 are distinct structures that correspond to layered, Mn-rich or spinel, and rock salt or disordered rock salt phases, respectively.

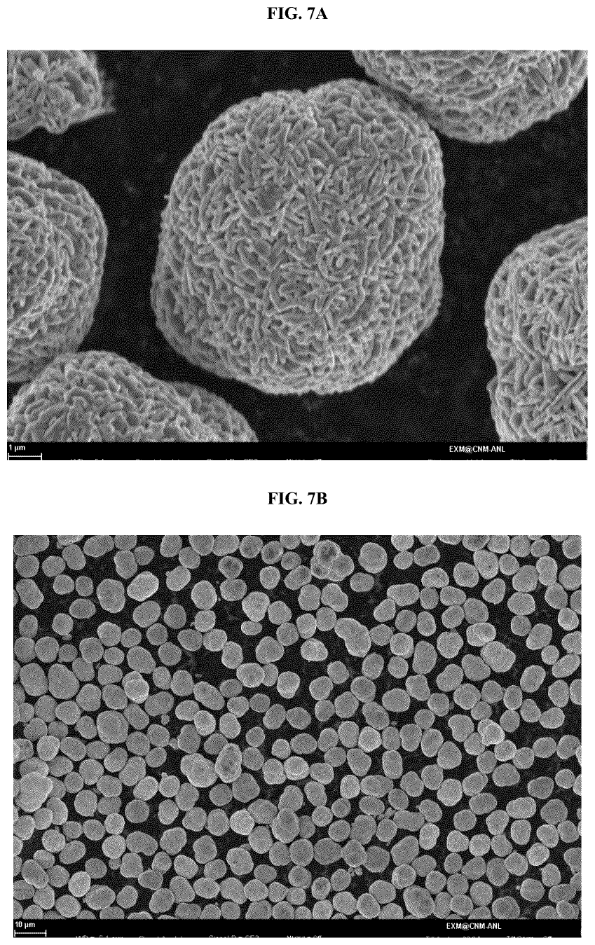

Example 6. The morphological characterization of the precursor for Example 2. The scanning electron microscopy (SEM) images of Example 2 are shown in FIGS. 7A and 7B. The precursor shows a uniform particle size with an average size of about 12 μm.

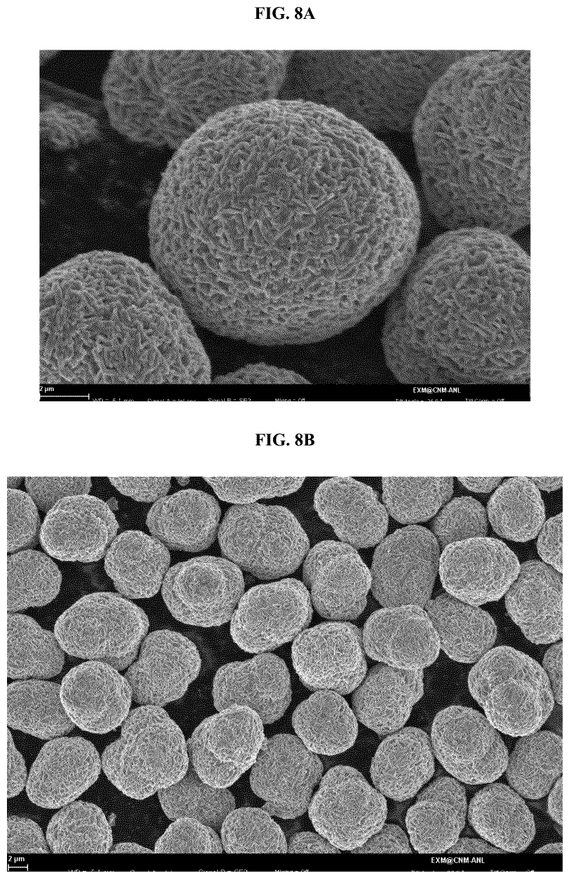

Example 7. The morphological characterization of the cathode material for Example 2. The SEM images of Example 2 are shown in FIGS. 8A and 8B. The cathode shows a similar morphology with the precursor. The particles have a uniform size with an average size of about 12 μm.

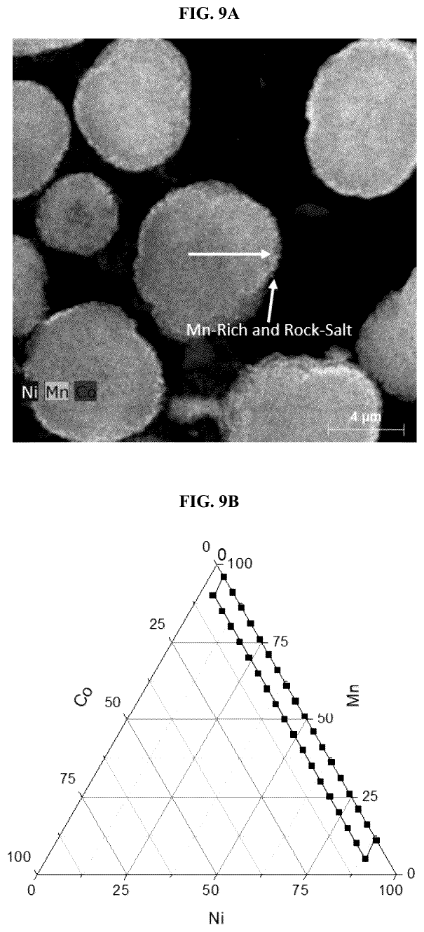

Example 8. The composition characterization of the cathode active material of Example 2. The synchrotron energy dispersive x-ray spectroscopy (EDS) images of Example 2 are shown in FIGS. 9A and 9B, wherein the Ni concentration decreased from 89 mol % to 25 mol % from the core to the surface; the Co concentration decreased from 6 mol % to 0 mol % from the core to the surface; and the Mn concentration increased from 25 mol % to 75 mol % from the core to the surface. FIG. 9B shows a ternary diagram incorporating all possible combinations of Example 2 compositions.

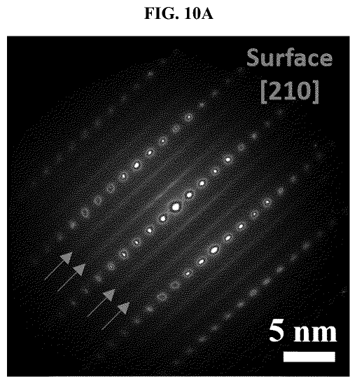

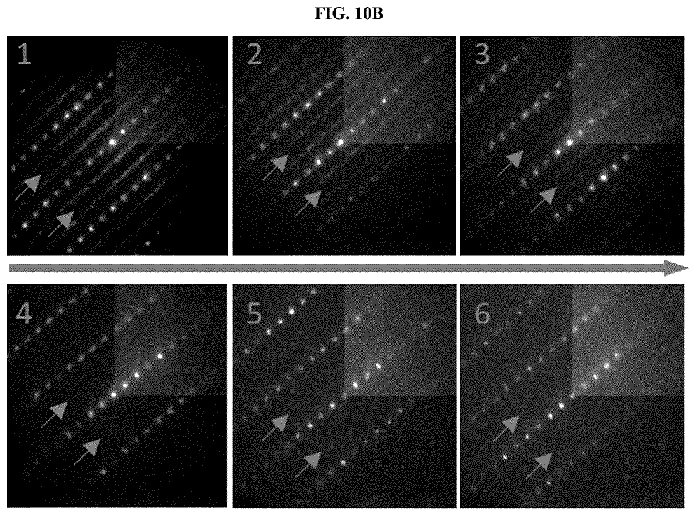

Example 9. The structural characterization of the cathode material for Example 2. The high-resolution transmission electron microscopy (TEM) images for the interlayer Mn-rich, M2 structure of Example 2 are shown in FIGS. 10A and 10B where the atomic structure of the inner most core is a layered structure, while the interlayer atomic structure is that of Mn-rich with faint characteristic trace lines present. FIG. 10B also shows the transition from interlayer to inner most core where the faint characteristic traces fade as Mn-rich face transitions to layered phase (images 1-6).

Example 10. The structural characterization of the cathode material for Example 2. The high-resolution transmission electron microscopy (TEM) images for the outer most layer rock salt or disordered rock salt, M3 structure of Example 2 are shown in FIGS. 11A and 11B where the atomic structure of the inner most core is a layered structure, the interlayer is a Mn-rich structure, and the atomic structure of the outer most layer surface is that of a rock salt or disordered rock salt structure. FIG. 11A shows the anti-site disordering where bright transition metal points are observable in faint lithium layers. FIG. 11B show the immediate outer most layer surface structure where rock salt or disordered rock salt layers transition to Mn-rich and layered structures when moving towards the interlayer and inner most core. As used herein, the term “anti-site disordering” refers to the antisites described above where the metal and Li positions are being exchanged.

Example 11. Illustrative batteries using [Li_{1+γ}(NiₓMn_{y}Co_{z})_{1-γ}O₂]_{α}^{M1}[Li_{1+δ}(Ni_{x′}Mn_{y′}Co_{z′})_{1-δ}O₂]_{β}^{M2}[Li_{1+ε}(Ni_{x″}Mn_{y″}Co_{z″})_{1-ε}O₂]_{1-α-β}^{M3}. For electrochemical testing, the cathode active material of Example 2 was mixed with carbon black and PVDF at a weight ratio of 80:10:10 and ground in a mortar. The well-mixed slurry was then cast onto a sheet of aluminum foil by a doctor blade on an automatic film coater. The film was dried in a vacuum oven at 80° C. for 12 h and then transferred to a glove box filled with argon, before being punched out as circular, 14 mm in diameter, disks. 2032 type coin cells were used to prepare lithium half cells. Celgard 2325 separators and 1.2 M LiPF₆ in EC/EMC (3:7) (EC is ethylene carbonate; EMC is ethylmethylcarbonate) electrolyte (i.e. GEN II electrolyte) were used. The half cells were assembled in an argon-filled glovebox, and then were operated by charge/discharge cycles.

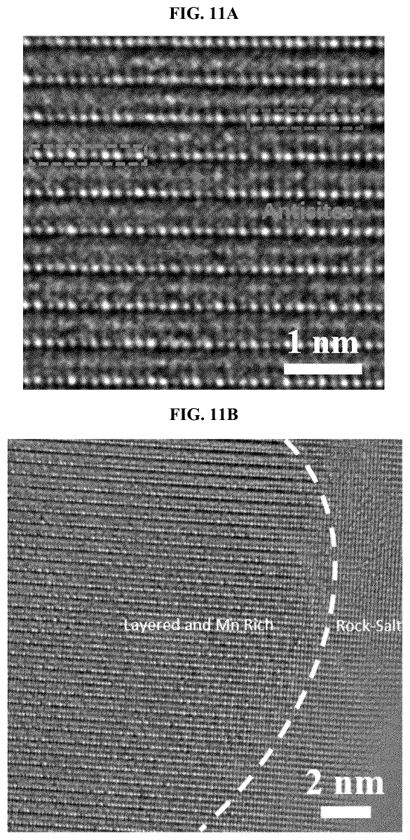

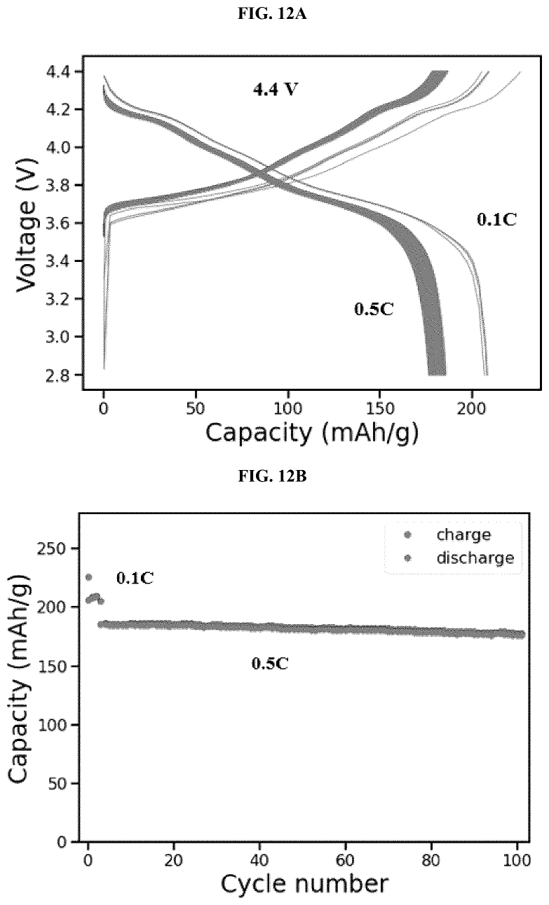

Example 12. Electrochemical properties of the cells from Example 2. FIGS. 12A and 12B depict the charge/discharge voltage profiles of the first 3 cycles at a charge/discharge rate of C/10 and following 100 cycles at a charge/discharge rate of C/2 at a voltage of 2.8 V to 4.4 V. As shown, the cathode shows a high initial specific capacity of 209 mAh g⁻¹ at the current rate of C/10 and an excellent capacity retention with minimal capacity degradation at the current rate of C/2 after 100 cycles.

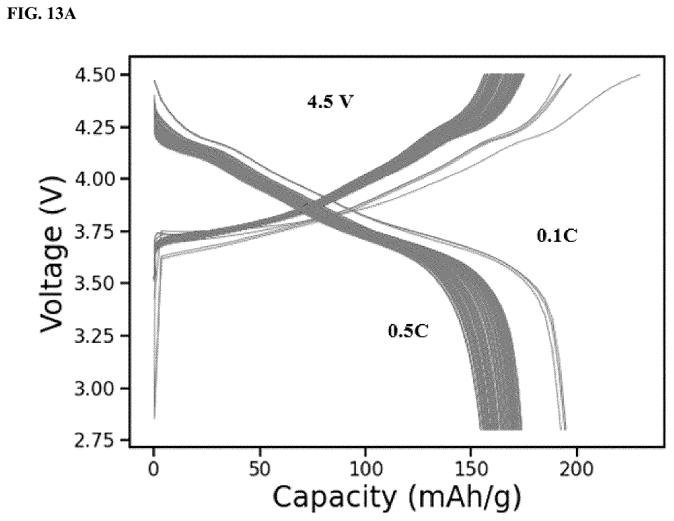

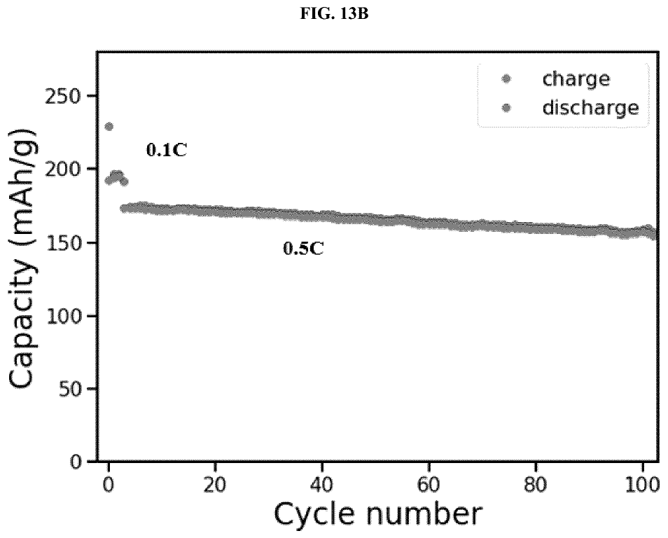

Example 13. FIGS. 13A and 13B depict the charge/discharge voltage profiles of the first 3 cycles at a charge/discharge rate of C/10 and following 100 cycles at a charge/discharge rate of C/2 at a voltage of 2.8 V to 4.5 V. As shown, the cathode shows a high initial specific capacity of 211 mAh g⁻¹ at the current rate of C/10 and an excellent capacity retention with minimal capacity degradation at the current rate of C/2 after 100 cycles.

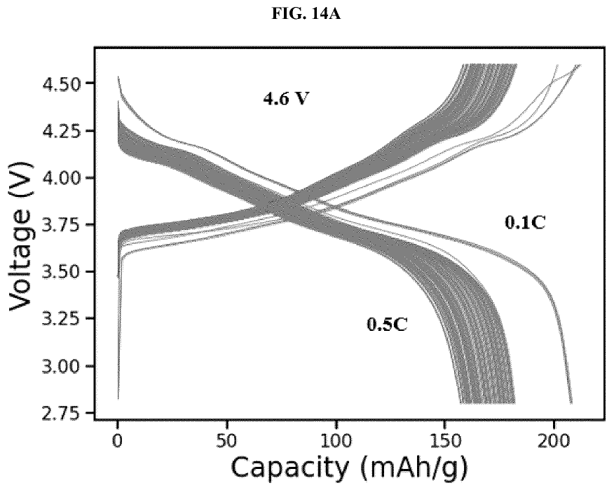

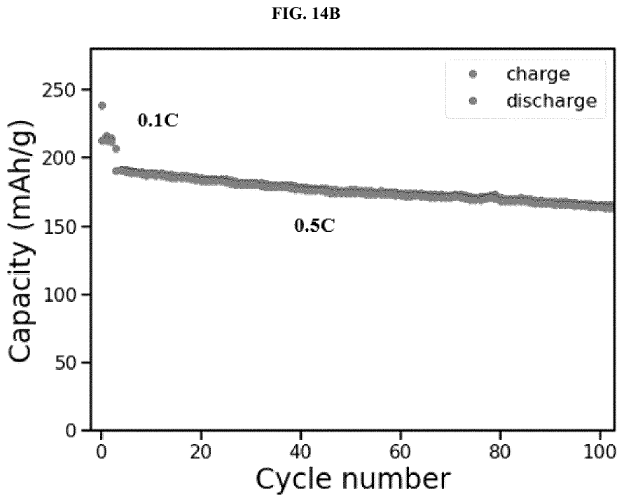

Example 14. FIGS. 14A and 14B depict the charge/discharge voltage profiles of the first 3 cycles at a charge/discharge rate of C/10 and following 100 cycles at a charge/discharge rate of C/2 at a voltage of 2.8 V to 4.6 V. As shown, the cathode shows a high initial specific capacity of 214 mAh g⁻¹ at the current rate of C/10 and an excellent capacity retention with minimal capacity degradation at the current rate of C/2 after 100 cycles.

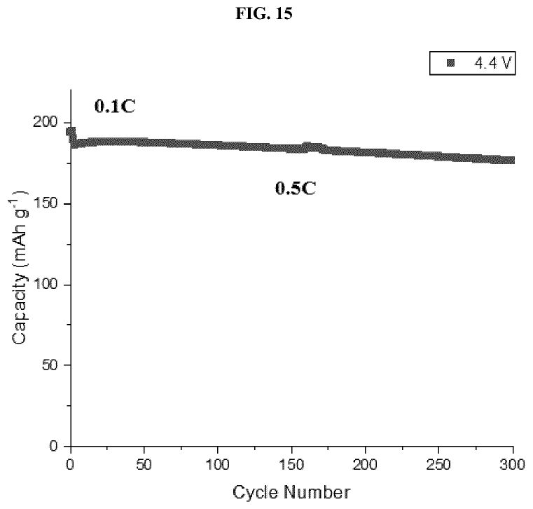

Example 15. FIG. 15 depicts the full cell cycle performance of Example 2 operating at a current rate of C/10 for the first 3 cycles and C/2 for the following 300 cycles at a cut-off potential of 4.4 V, respectively. As shown, the cathode shows ultra-stable cycle performance at potentials of 4.4 V. The capacity retention of the two cells is almost 95% after 300 cycles.

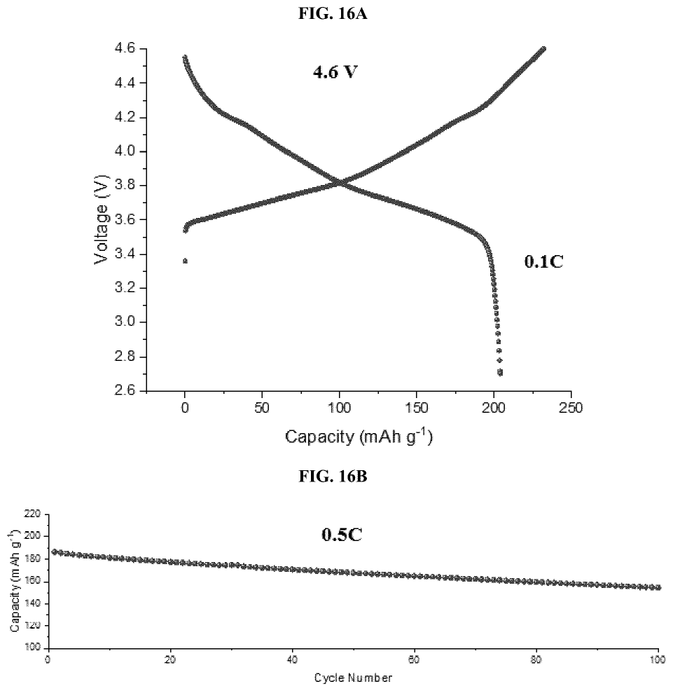

Example 16 (comparative). FIG. 16A depicts the initial cycle and 16B depicts the cycle performance of uniform NMC811 (i.e. a constant concentration cathode material—no gradient—having 80 mol % Ni, 10 mol % Mn, and 10 mol % Co) during 100 cycles at a rate of C/2 within at a voltage of 2.8 V to 4.6 V. As shown, uniform NMC811 shows a fast capacity degradation within 100 cycles.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation, or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed is:

1. A cathode active material comprising a plurality of cathode active particles, each particle comprising a composition expressed as:
[Li_{1+γ}(NiₓMn_{y}Co_{z})_{1-γ}O₂]_{α}^{M1}[Li_{1+δ}(Ni_{x′}Mn_{y′}Co_{z′})_{1-δ}O₂]_{β}^{M2}[Li_{1+ε}(Ni_{x′}Mn_{y′}Co_{z′})_{1-ε}O₂]_{1-α-β}^{M3}; or
[Na_{1+γ}(NiₓMn_{y}Co_{z})_{1-γ}O₂]_{α}^{M1}[Na_{1+δ}(Ni_{x′}Mn_{y′}Co_{z′})_{1-δ}O₂]_{β}^{M2}[Na_{1+ε}(Ni_{x″}Mn_{y″}Co_{z″})_{1-ε}O₂]_{1-α-β}^{M3};
wherein:
M1 is a structure having a layered phase;
M2 has structure comprising a Mn-rich and/or spinel phase;
M3 has a rock salt or disordered rock salt phase;
M1, M2, and M3 have different formulae;
an inner most core portion of the particle is one of M1, M2, or M3;
an interlayer may be any one of the remaining two of M1, M2, or M3;
an outer most layer may be the remaining member of M1, M2, or M3;
0≤α<1, 0<β<1, −0.1≤γ≤0.1, −0.3≤δ≤0.3, −0.5≤ε≤0.5, 0≤x≤1, 0≤y≤0.5, 0≤z≤1, 0≤x′≤0.5, 0.5≤y′≤1, 0≤z′≤0.5, and 0≤x″≤1, 0≤y″≤1, 0≤z″≤1; and
the sum of x, y and z is 1, the sum of x′, y′ and z′ is 1, and the sum of x″, y″, and z″ is 1.

2. The cathode active material of claim 1, wherein the particle comprises M1 as the inner most core, M2 as the interlayer, and M3 as the outer most layer.

3. The cathode active material of claim 1, wherein the particle comprises M2 as the inner most core, M3 as the interlayer, and M3 as the outer most layer.

4. The cathode active material of claim 1, wherein the outer most layer is from 0.01 to 2 μm in thickness.

5. The cathode active material of claim 1, wherein 0.8≤α≤1, 0≤β<0.2, 0.6≤x≤1, 0≤y≤0.4, 0≤z≤0.4, 0≤x′≤0.5, 0.5≤y′≤1, 0≤z′≤0.4, 0≤x″≤0.4, 0.5≤y″≤1, and 0≤z″≤0.4.

6. The cathode active material of claim 1, 0.9≤α<1, 0<β<0.1, 0≤x≤0.2, 0.8≤y≤1, 0≤z≤0.2, 0≤x′≤0.5, 0.5≤y′≤1, 0.5≤z′≤1, 0≤x″≤0.2, 0.5≤y″≤1, and 0≤z≤0.2.

7. The cathode active material of claim 1, wherein the interlayer and outer most layer comprises about 60 mol % to about 90 mol % Mn.

8. The cathode material of claim 1, wherein each particle exhibits a generally spherical morphology and having a radius vector defined directionally from an inner portion of the particle to an outer portion.

9. The cathode material of claim 8, wherein the composition has greater than 50% by weight Ni, and the Ni concentration is constant or partly/continuously decreased from particle center to surface, the Co concentration is constant or partly/continuously decreases or increases nearer the surface of the particle, and the Mn concentration partly/continuously increases toward the surface of the particle.

10. The cathode material of claim 8, when the composition has greater than 50% by weight Mn, and the Mn concentration is constant or partly/continuously decreased from particle center to surface, the Co concentration is constant or partly/continuously decreases or increases nearer the surface of the particle, and the Ni concentration partly/continuously increases toward the surface of the particle.

11. The cathode active material of claim 8, wherein a concentration of Ni, Mn, and/or Co in any of M1, M2, and M3 changes by one or more slopes.

12. The cathode active material of claim 1 further comprising a dopant cation.

13. The cathode active material of claim 12, wherein the composition is expressed as:
[Li_{1+γ}(NiₓMn_{y}Co_{z}T_{ζ})_{1-γ}O₂]_{α}^{M1}[Li_{1+δ}(Ni_{x′}Mn_{y′}Co_{z′}T′_{η})_{1-δ}O₂]_{β}^{M2}[Li_{1+ε}(Ni_{x″}Mn_{y″}Co″T″_{θ})_{1-ε}O₂]_{1-α-β}^{M3}, or
[Na_{1+γ}(NiₓMn_{y}Co_{z}T_{ζ})_{1-γ}O₂]_{α}^{M1}[Na_{1+δ}(Ni_{x′}Mn_{y′}Co_{z′}T′_{η})_{1-δ}O₂]_{β}^{M2}[Na_{1+ε}(Ni_{x″}Mn_{y″}Co_{z″}T″_{θ})_{1-ε}O₂]_{1-α-β}^{M3};
wherein:
T, T′, T″ are dopant cations and are individually an alkaline earth metal, a transition metal other than Ni, Mn, and Co, or a combination of any two or more thereof;
0≤ζ≤0.1, 0≤η≤0.1, 0≤θ≤0.1, 0≤α<1, 0<β<1, −0.1≤γ≤0.1, −0.3≤δ≤0.3, −0.5≤ε≤0.5, 0≤x≤1, 0≤y≤0.5, 0≤z≤1, 0≤x′≤0.5, 0.5≤y′≤1, 0≤z′≤0.5, and 0≤x″≤1, 0≤y″≤1, 0≤z″≤1; and
the sum of x, y and z is 1, the sum of x′, y′ and z′ is 1, and the sum of x″, y″, and z″ is 1.

14. The cathode active material of claim 8 further comprising a surface coating over the outer most layer of the particle.

15. The cathode active material of claim 14, wherein the surface coating comprises a metal oxide, a metal fluoride, a metal phosphate, a conductive carbon coating, a conductive polymer, or a combination of any two or more thereof.

16. The cathode active material of claim 1 further comprising additional interlayers MX, where X is an integer greater than 3.

17. A cathode active material comprising:
a composition expressed as:
[Li_{1+γ}(NiₓMn_{y}Co_{z})_{1-γ}O₂]_{α}^{M1}[Li_{1+δ}(Ni_{x′}Mn_{y′}Co_{z′})_{1-δ}O₂]_{β}^{M2}[Li_{1+ε}(Ni_{x″}Mn_{y″}Co_{z″})_{1-ε}O₂]_{φ}^{M3}[Li_{1+μ}(Ni_{x′″}Mn_{y′″}Co_{z′″})_{1-μ}O₂]_{1-α-β-φ}^{MX}; or
[Na_{1+γ}(NiₓMn_{y}Co_{z})_{1-γ}O₂]_{α}^{M1}[Na_{1+δ}(Ni_{x′}Mn_{y′}Co_{z′})_{1-δ}O₂]_{β}^{M2}[Na_{1+ε}(Ni_{x″}Mn_{y″}Co_{z″})_{1-ε}O₂]_{φ}^{M3}[Na+μ(Ni_{x′″}Mn_{y′″}Co_{z′″})_{1-μ}O₂]_{1-α-β-φ}^{MX}
wherein:
M1 is a structure comprising a layered phase;
M2 is a structure comprising a Mn-rich and/or spinel phase;
M3 is a structure comprising a rock-salt or disordered rock-salt phase;
MX is a composite structure comprising a layered, Mn-rich, and/or spinel, or rock salt and/or disordered rock salt phase;
MX is absent or present and when present represents additional layers where X is greater than 3;
0≤α<1, 0<β<1, 0≤φ≤1, −0.1≤γ≤0.1, −0.3≤δ≤0.3, −0.5≤ε≤0.5, −0.7≤μ≤0.7, 0≤x≤1, 0≤y≤0.5, 0≤z≤1, 0≤x′≤0.5, 0.5≤y′≤1, 0≤z′≤0.5, 0≤x″≤1, 0≤y″1, 0≤z″≤1, and 0≤x′″≤1, 0≤y′″≤1, and 0≤z′″≤1; and
the sum of x, y and z is 1, the sum of x′, y′ and z′ is 1, the sum of x″, y″, and z″ is 1, and the sum of x′″, y′″, and z′″ is 1.

18. A process of preparing a cathode active material, the process comprising:
providing a first aqueous metal ion solution;
providing a second aqueous metal ion solution;
providing a third aqueous metal ion solution;
optionally, providing additional aqueous metal ion solutions X where X>3;
combining the first, second, third, and, optionally additional metal solutions with a precipitating agent to form a precipitate;
isolating the precipitate;
mixing the precipitate with a lithium or sodium salt to form a mixture; and
heating-treating the mixture to form the cathode active material that is expressed as:
[Li_{1+γ}(NiₓMn_{y}Co_{z})_{1-γ}O₂]_{α}^{M1}[Li_{1+δ}(Ni_{x′}Mn_{y′}Co_{z′})_{1-δ}O₂]_{β}^{M2}[Li_{1+ε}(Ni_{x′}Mn_{y′}Co_{z′})_{1-ε}O₂]_{1-α-β}^{M3}; or
[Na_{1+γ}(NiₓMn_{y}Co_{z})_{1-γ}O₂]_{α}^{M1}[Na_{1+δ}(Ni_{x′}Mn_{y′}Co_{z′})_{1-δ}O₂]_{β}^{M2}[Na_{1+ε}(Ni_{x″}Mn_{y″}Co_{z″})_{1-ε}O₂]_{1-α-β}^{M3};
wherein:
M1 represents a structure having a layered phase;
M2 represents a structure having a Mn-rich and/or spinel phase;
M3 represents a structure having a rock-salt or disordered rock-salt phase;
0≤α<1, 0<β<1, −0.1≤γ≤0.1, −0.3≤δ≤0.3, −0.5≤ε≤0.5, 0≤x≤1, 0≤y≤0.5, 0≤z≤1, 0≤x′≤0.5, 0.5≤y′≤1, 0≤z′≤0.5, and 0≤x″≤1, 0≤y″≤1, 0≤z″≤1; and the sum of x, y, and z is 1, the sum of x′, y′, and z′ is 1, and the sum of x″, y″, and z″ is 1.

19. The process of claim 18, wherein M1 and/or M2 and/or M3 are established in particles of the precipitate along a vector radius defined from the center of the particle to the surface; a concentration gradient of Ni, Mn, and Co of M1, M2, and M3 is established in particles of the precipitate along a vector radius defined from the center of the particle to the surface.

20. The process of claim 19, wherein: the heat-treating comprises calcination at a temperature of about 680° C. to about 1200° C., and the calcination step is conducted in an oxygen atmosphere, an air atmosphere, or in an oxygen-enriched air atmosphere.
